(19) United States
(12) Patent Application Publication
(10) Pub. No.: US 2010/0150802 A1
(43) Pub. Date: Jun. 17, 2010

(54) PROCESSING CO2 UTILIZING A RECIRCULATING SOLUTION

(76) Inventors: Ryan J. GILLIAM, Campbell, CA (US); Valentin Decker, Menlo Park, CA (US); Michael Kostowskyj, Campbell, CA (US); Brent R. Constantz, Portola Valley, CA (US); Kasra Farsad, San Jose, CA (US); Miguel Fernandez, San Jose, CA (US); Sidney Omelon, Los Gatos, CA (US)

Correspondence Address: Calera Corporation;Eric Witt, 14600 Winchester Blvd., Los Gatos, CA, 95032, US

(21) Appl. No.: 12/636,580

(22) Filed: Dec. 11, 2009

Related U.S. Application Data
(60) Provisional application No. 61/121,872, filed on Dec. 11, 2008.
(60) Provisional application No. 61/170,086, filed on Apr. 16, 2009.
(60) Provisional application No. 61/178,475, filed on May 14, 2009.
(60) Provisional application No. 61/239,429, filed on Sep. 2, 2009.
(60) Provisional application No. 61/254,640, filed on Oct. 23, 2009.

(51) Int. Cl. C01B 31/20; B01J 10/00

(52) U.S. Cl. 423/220; 422/187

(57) ABSTRACT

In some embodiments, the invention provides, a method comprising a) contacting a solution with an industrial source of carbon dioxide to produce a CO₂-charged solution; b) subjecting the CO₂-charged solution to conditions sufficient to produce a composition, wherein the composition comprises carbonates, bicarbonates, or carbonates and bicarbonates; c) separating a supernatant from the composition; and d) recirculating at least a portion of the supernatant for contact with the industrial source of carbon dioxide. In some embodiments, the invention provides a system comprising a) a processor configured to produce a composition from an industrial source of carbon dioxide, wherein the composition comprises precipitation material comprising carbonates, bicarbonates, or carbonates and bicarbonates and a treatment system configured to separate a supernatant from the composition, wherein the processor and the treatment system are operably connected for recirculation of at least a portion of the supernatant.

### CROSS-REFERENCE

This application claims the benefit of U.S. Provisional Patent Application No. 61/121,872, filed 11 Dec. 2008, titled “Sequestering CO₂ Utilizing a Circulating Liquid”; U.S. Provisional Patent Application No. 61/170,086, filed 16 Apr. 2009, titled “Apparatus, Systems, and Methods for Treating Industrial Waste”; U.S. Provisional Patent Application No. 61/178,475, filed 14 May 2009, titled “Apparatus, Systems, and Methods for Treating Industrial Waste”; U.S. Provisional Patent Application No. 61/239,429, filed 2 Sep. 2009, titled “Apparatus, Systems, and Methods for Treating Industrial Waste”; U.S. Provisional Patent Application No. 61/254,640, filed 23 Oct. 2009, titled “Apparatus, Systems, and Methods for Treating Industrial Waste,” each of which is incorporated herein by reference in its entirety.

### BACKGROUND

Carbon dioxide (CO₂) emissions have been identified as a major contributor to the phenomenon of global warming. CO₂ is a by-product of combustion and it creates operational, economic, and environmental problems. It is expected that elevated atmospheric concentrations of CO₂ and other greenhouse gases will facilitate greater storage of heat within the atmosphere leading to enhanced surface temperatures and rapid climate change. In addition, elevated levels of CO₂ in the atmosphere are also expected to further acidify the world's oceans due to the dissolution of CO₂ and formation of carbonic acid. The impact of climate change and ocean acidification will likely be economically expensive and environmentally hazardous if not timely handled. Reducing potential risks of climate change will require sequestration or sequestration and avoidance of CO₂ from various anthropogenic processes.

### INCORPORATION BY REFERENCE

All publications, patents, and patent applications mentioned in this specification are incorporated herein by reference to the same extent as if each individual publication, patent, or patent application was specifically and individually indicated to be incorporated by reference. As such, each of the following are incorporated herein by reference: U.S. patent application Ser. No. 12/126,776, filed 23 May 2008, titled “Hydraulic Cements Comprising Carbonate Compound Compositions”; U.S. patent application Ser. No. 12/163,205, filed 27 Jun. 2008, titled “Desalination Methods and Systems that Include Carbonate Compound Precipitation”; U.S. Provisional Patent Application No. 61/017,405, filed 28 Dec. 2007, titled “Method of Sequestering CO₂”; U.S. Provisional Patent Application 61/081,299, filed 16 Jul. 2008, titled “Low Energy Ph Modulation For Carbon Sequestration Using Hydrogen Absorptive Metal Catalysts”; U.S. Provisional Patent Application No. 61/088,347, filed 13 Aug. 2007, titled “High Yield CO₂ Sequestration Product Production”; U.S. Provisional Patent Application No. 61/091,729, filed 25 Aug. 2008, titled “Low Energy Absorption of Hydrogen Ion from an Electrolyte Solution into a Solid Material”; and U.S. patent application Ser. No. 12/344,019, filed 24 Dec. 2008, titled “Methods of Sequestering CO₂.”

### SUMMARY

In some embodiments, the invention provides a method comprising a) contacting a solution with an industrial source of carbon dioxide to produce a CO₂-charged solution; b) subjecting the CO₂-charged solution to conditions sufficient to produce a composition comprising carbonates, bicarbonates, or carbonates and bicarbonates; c) treating the composition to produce a concentrated composition, wherein treating the composition comprises 1) dewatering the composition to increase the concentration of carbonates, bicarbonates, or carbonates and bicarbonates in the resulting concentrated composition and to simultaneously produce a supernatant and 2) filtering the supernatant to produce a filter stream; and d) providing at least a portion of the filter stream to an electrochemical process for producing proton-removing agents.

In some embodiments, the invention provides a system comprising a) a processor configured to produce a composition from an industrial source of carbon dioxide, wherein the composition comprises carbonates, bicarbonates, or carbonates and bicarbonates; b) a treatment system configured to concentrate the composition, wherein the treatment system comprises 1) a dewatering system configured to concentrate carbonates, bicarbonates, or carbonates and bicarbonates in a resulting concentrated composition and simultaneously produce a supernatant and 2) a filtration system configured to produce a filter stream from the supernatant; and c) an electrochemical system configured to receive at least a portion of the filter stream.

In some embodiments, the invention provides, a method comprising a) contacting a solution with an industrial source of carbon dioxide to produce a CO₂-charged solution; b) subjecting the CO₂-charged solution to conditions sufficient to produce a slurry comprising precipitation material, wherein the precipitation material comprises carbonates, bicarbonates, or carbonates and bicarbonates; c) separating a supernatant from the slurry; and d) recirculating at least a portion of the supernatant for contact with the industrial source of carbon dioxide. In some embodiments, the precipitation material comprises carbonates, bicarbonates, or carbonates and bicarbonates of alkaline earth metals. In some embodiments, the alkaline earth metals are selected from the group consisting of calcium, magnesium, or a combination of calcium and magnesium. In some embodiments, the precipitation material further comprises strontium. In some embodiments, the precipitation material further comprises 3 to 10,000 ppm strontium. In some embodiments, separating the supernatant from the slurry comprises dewatering the slurry to produce a dewatering supernatant. In some embodiments, dewatering the slurry comprises primary dewatering and secondary dewatering. In some embodiments, primary dewatering produces a primary dewatered product comprising 5-40% solids and a primary dewatering supernatant. In some embodiments, primary dewatering supernatant is provided to the solution for contact with the industrial source of carbon dioxide. In some embodiments, the solution for contact with the industrial source of carbon dioxide comprises at least 50% primary dewatering supernatant. In some embodiments, secondary dewatering produces a secondary dewatered product comprising 35-99% solids and a secondary dewatering supernatant. In some embodiments, secondary dewatering supernatant is provided to the solution for contact with the industrial source of carbon dioxide. In some embodiments, the solution for contact with the industrial source of carbon dioxide comprises at least 25% secondary dewatering supernatant. In some embodiments, the solution for contact with the industrial source of carbon dioxide comprises at least 75% dewatering supernatant. In some embodiments, the method further comprises filtering the dewatering supernatant in a filtration system comprising at least one filtration unit. In some embodiments, the filtration unit produces a filtration unit retentate and a filtration unit permeate. In some embodiments, the filtration system comprises an ultrafiltration unit an ultrafiltration unit, a nanofiltration unit, a reverse osmosis unit, or combinations of the foregoing filtration units. In some embodiments, the dewatering supernatant is treated in a nanofiltration unit to produce a nanofiltration retentate and a nanofiltration permeate. In some embodiments, at least a portion of nanofiltration unit permeate is processed in an electrochemical process to produce proton-removing agents. In some embodiments, the nanofiltration unit retentate comprises a concentration of alkaline earth metals that is at least 50% greater than that of the dewatering supernatant. In some embodiments, the dewatering supernatant is treated in a reverse osmosis unit to produce a reverse osmosis retentate and a reverse osmosis permeate. In some embodiments, at least a portion of reverse osmosis unit permeate is processed in an electrochemical process to produce proton-removing agents. In some embodiments, the reverse osmosis unit retentate comprises a concentration of alkaline earth metals that is at least 50% greater than that of the supernatant. In some embodiments, the solution that is contacted with the industrial source of carbon dioxide comprises filtration unit retentate. In some embodiments, the method further comprises demineralizing at least a portion of the filtration unit retentate to produce a demineralized filtration unit retentate and processing the demineralized filtration unit retentate in an electrochemical process to produce proton-removing agents. In some embodiments, the method further comprises demineralizing and concentrating at least a portion of the filtration unit retentate to produce a demineralized and concentrated filtration unit retentate and processing the demineralized and concentrated filtration unit retentate in an electrochemical process to produce proton-removing agents. In some embodiments, recirculating the supernatant for contact with the industrial source of carbon dioxide results in a reduction in total parasitic load of at least 4% when compared to a once-through process. In some embodiments, recirculating the supernatant for contact with the industrial source of carbon dioxide results in a reduction in total parasitic load of at least 8% when compared to a once-through process.

In some embodiments, the invention provides a method comprising a) contacting an alkaline earth metal-containing solution with an industrial source of carbon dioxide to produce a CO₂-charged solution; b) subjecting the CO₂-charged solution to conditions sufficient to produce a slurry comprising precipitation material, wherein the precipitation material comprises carbonates, bicarbonates, or carbonates and bicarbonates of alkaline earth metals, and wherein conditions sufficient to produce the slurry comprise utilizing proton-removing agents from a natural source, from an industrial waste source, produced in an electrochemical process, or a combination thereof; c) separating a supernatant from the slurry; d) filtering the supernatant through a filtration system to produce a filter stream; and e) recirculating at least a portion of the filter stream for contact with the industrial source of carbon dioxide or for production of proton-removing agents in the electrochemical process.

In some embodiments, the invention provides a system comprising a) a processor configured to produce a slurry from an industrial source of carbon dioxide, wherein the slurry comprises precipitation material comprising carbonates, bicarbonates, or carbonates and bicarbonates and a treatment system configured to separate a supernatant from the slurry, wherein the processor and the treatment system are operably connected for recirculation of at least a portion of the supernatant. In some embodiments, the treatment system comprises a dewatering system configured to separate the supernatant from the slurry. In some embodiments, the dewatering system is configured to produce a dewatering supernatant. In some embodiments, the dewatering system comprises a primary dewatering system and a secondary dewatering system. In some embodiments, the primary dewatering system is configured to produce a primary dewatered product comprising 5-40% solids and a primary dewatering supernatant. In some embodiments, the secondary dewatering system is configured to produce a secondary dewatered product comprising 35-99% solids and a secondary dewatering supernatant. In some embodiments, the treatment system further comprises a filtration system for filtering the dewatering supernatant, wherein the filtration system comprises at least one filtration unit. In some embodiments, the dewatering system is configured to provide the dewatering supernatant to the filtration system. In some embodiments, the filtration unit is configured to produce filtration unit retentate and a filtration unit permeate. In some embodiments, the filtration system comprises an ultrafiltration unit, a nanofiltration unit, a reverse osmosis unit, or combinations of the foregoing filtration units. In some embodiments, the dewatering system is configured to provide the dewatering supernatant to a nanofiltration unit. In some embodiments, the nanofiltration unit is configured to produce a nanofiltration unit retentate comprising a concentration of alkaline earth metals that is at least 50% greater than that of the dewatering supernatant. In some embodiments, the dewatering system is configured to provide the dewatering supernatant to a reverse osmosis unit. In some embodiments, the reverse osmosis unit is configured to produce a reverse osmosis unit retentate comprising a concentration of alkaline earth metals that is at least 50% greater than that of the dewatering supernatant. In some embodiments, the processor comprises a contactor selected from the group consisting of a gas-liquid contactor and a gas-liquid-solid contactor. In some embodiments, the contactor is a multi-stage contactor. In some embodiments, the contactor is configured to utilize the filtration unit retentate provided by the filtration unit. In some embodiments, the contactor is further configured to utilize make-up water. In some embodiments, the system further comprises an electrochemical system configured to produce proton-removing agents. In some embodiments, the electrochemical system is configured to produce hydroxide, bicarbonate, carbonates, or a combination thereof. In some embodiments, the electrochemical system is configured to use filtration unit permeate from the at least one filtration unit. In some embodiments, the electrochemical system is configured to use filtration unit retentate from the at least one filtration unit. In some embodiments, the filtration unit is a nanofiltration unit. In some embodiments, the filtration unit is a reverse osmosis unit. In some embodiments, the system further comprises a demineralization unit for demineralizing filtration unit permeate. In some embodiments, the system further comprises a demineralization unit for demineralizing filtration unit retentate. In some embodiments, the system further comprises a concentration unit operably connected to the demineralization unit. In some embodiments, the system provides a reduction in total parasitic load of at least 4% when compared to a system configured for a once-through process.

In some embodiments, the invention provides a system comprising a) a processer configured for contacting an alkaline earth metal-containing solution with an industrial source of carbon dioxide and for producing a slurry comprising precipitation material, wherein the precipitation material comprises carbonates, bicarbonates, or carbonates and bicarbonates of alkaline earth metals, and wherein the processor is further configured to utilize proton-removing agents from a natural source, from an industrial waste source, produced in an electrochemical system, or any combination thereof; b) a dewatering system configured to separate a supernatant from the slurry; and c) a filtration system configured to filter the supernatant and produce a filter stream, wherein the processor, the dewatering system, and the filtration system are operably connected for recirculation of at least a portion of the filter stream. In some embodiments, the system further comprises an electrochemical system configured to produce proton-removing agents. In some embodiments, the processor, the dewatering system, the filtration unit, and the electrochemical system are operably connected for recirculation of at least a portion of the supernatant.

In some embodiments, the invention provides a method comprising a) contacting a solution with an industrial source of carbon dioxide to produce a CO₂-charged solution; b) subjecting the CO₂-charged solution to conditions sufficient to produce a composition comprising carbonates, bicarbonates, or carbonates and bicarbonates; c) treating the composition to produce a supernatant; and d) providing at least a portion of the supernatant to an electrochemical process for producing proton-removing agents, wherein the electrochemical process produces chlorine at the anode, oxygen at the anode, or no gas at the anode.

In some embodiments, the invention provides a system comprising a) a processor configured to produce a composition from an industrial source of carbon dioxide, wherein the composition comprises carbonates, bicarbonates, or carbonates and bicarbonates; b) a treatment system configured to produce a supernatant from the composition; and c) an electrochemical system comprising an anode, wherein the electrochemical system is configured to produce proton-removing agents from at least a portion of the supernatant, and wherein the electrochemical system is configured to produce chlorine at the anode, oxygen at the anode, or no gas at the anode.

In some embodiments, the invention provides a method of processing carbon dioxide, comprising contacting carbon dioxide with a recirculating solution. In some embodiments, the recirculating solution comprises an alkaline solution. In some embodiments, the recirculating solution comprises a solution depleted of alkaline earth metal ions. In some embodiments, the method further comprises producing the recirculating solution by precipitating carbonates and/or bicarbonates of alkaline earth metals from a solution comprising salt water, freshwater, brine, brackish water, or a solution of rich in minerals comprising alkaline earth metals. In some embodiments, the method comprises separating the recirculating liquid from the precipitated carbonates and/or bicarbonates of alkaline earth metals. In some embodiments, the method further comprises removing certain cations and anions from the recirculating solution by nanofiltration, water softening, reverse osmosis, desalination, or electrodialysis. In some embodiments, the method further comprises adding an alkaline solution to the recirculating solution. In some embodiments, the recirculating solution comprises sodium hydroxide or magnesium hydroxide solution. In some embodiments, the method further comprises precipitating carbonates and/or bicarbonates in the recirculating solution. In some embodiments, the method further comprises adding salt water, seawater, freshwater, brine, or brackish water to the recirculating solution. In some embodiments, the method further comprises adjusting the pH of the recirculating solution from about pH 8 to about pH 14. In some embodiments, the recirculating solution comprises a pH of about pH 10.5. In some embodiments, the method further comprises incorporating the carbonates and/or bicarbonates into a building material or product. In some embodiments, the method further comprises pumping a portion of the recirculating solution to an ocean depth or reservoir depth at which the temperature and pressure are sufficient to keep the CO₂ in solution.

In some embodiments, the invention provides a method of desalinating a solution comprising contacting carbon dioxide with a recirculating solution. In some embodiments, the method further comprises precipitating carbonates and/or bicarbonates of alkaline earth metals from a solution comprising the recirculating solution.

In some embodiments, the invention provides a method of making a building material or product comprising precipitating carbonates and/or bicarbonates by contacting carbon dioxide with a recirculating solution. In some embodiments, the method further comprises processing the precipitation material into a building material or product.

In some embodiments, the invention provides a system of processing carbon dioxide comprising a source of carbon dioxide gas; a recirculating solution suitable for absorbing carbon dioxide; and a source of alkaline earth metal ions, wherein by contacting the carbon dioxide with the recirculating solution and the alkaline earth metal ions, carbonates and/or bicarbonates are precipitated from the recirculating carbon-sequestrating liquid. In some embodiments, the system further comprises a dewatering system for separating the recirculating solution from the precipitation material. In some embodiments, the system further comprises a processor, wherein the recirculating solution is contacted with the carbon dioxide and the source of alkaline earth metal ions.

In some embodiments, the invention provides systems and methods for processing carbon dioxide comprising absorbing carbon dioxide in a recirculating solution; adjusting the pH to promote carbon dioxide absorption; adding alkaline earth metal ions; producing a composition comprising carbonates, bicarbonates, or carbonates and bicarbonates, as well as other species (e.g., strontium); concentrating the composition; and subsequently recycling the supernatant for further gas absorption. By using a recirculating solution, usage of water, alkaline earth metal ions, and chemical additives (e.g., proton-removing agents such as hydroxides) may be optimized.

In some embodiments, the recirculating solution initially comprises a solution substantially depleted of alkaline earth metal ions and dissolved carbon dioxide. The solution may be obtained by precipitating carbonates, bicarbonates, or carbonates and bicarbonates of alkaline earth metals from a solution (i.e., the recirculating solution initially comprises at least a portion of supernatant formed by precipitating carbonates, bicarbonates, or carbonates and bicarbonates from a solution comprising dissolved CO₂). In various embodiments, the recirculating solution initially comprises an alkaline solution comprising sodium hydroxide and/or magnesium hydroxide.

Thereafter, the pH of the recirculating solution may be adjusted to promote absorption of CO₂, and may be mixed with a solution comprising alkaline earth metal ions. As a result of mixing the solutions, a composition of carbonates, bicarbonates, or carbonates and bicarbonates of alkaline earth metals (e.g., precipitation material comprising CaCO₃ and/or MgCO₃) may be formed and precipitated from the supernatant. In some embodiments, the supernatant may be decanted and recirculated as the recirculating solution. In some embodiments, the composition comprising carbonates, bicarbonates, or carbonates and bicarbonates may be dewatered (e.g. filtered) and the filtrate recirculated as the recirculating solution.

In various embodiments, the recirculating solution comprises a solution wherein the pH ranges from about pH 8 to about pH 14; optionally, the pH is about pH 10.5. Also, optionally, the pH of the recirculating solution may be adjusted by adding hydroxide ions (e.g., sodium hydroxide, magnesium hydroxide, etc.) to the liquid.

In various embodiments, compositions comprising carbonates, bicarbonates, or carbonates and bicarbonates of alkaline earth metals (e.g., precipitation material) are obtained upon contacting the recirculating solution with a CO₂-containing gas. In various embodiments, the concentration of alkaline earth metal ions in the recirculating solution is increased prior to contact with the CO₂-containing gas. In some embodiments, the alkaline earth metal ions are obtained from a source of alkalinity (e.g., seawater), whereas in other embodiments, the alkaline earth metals are obtained by digesting mafic minerals (e.g., olivine in an aqueous acidic solution) as described in U.S. patent application Ser. No. 12/501,217, filed 10 Jul. 2009, which is incorporated herein by reference.

In an optional step, the recirculating solution is processed to selectively remove cations and anions prior to contacting the recirculating solution with the CO₂-containing gas. In this optional step, the solution is subsequently processed in an electrochemical step to increase the pH by forming hydroxide, bicarbonate, and/or carbonate as described in U.S. patent application Ser. No. 12/617,005, filed 12 Nov. 2009, which is incorporated herein by reference. Thereafter the solution is contacted with CO₂ and alkaline earth metal ions for preparation of the composition comprising carbonates, bicarbonates, or carbonates and bicarbonates (e.g., precipitation material), and subsequently recirculation.

In various embodiments, precipitation material from the recirculating solution is useable in building materials or products such as cements as described, for example, in commonly assigned U.S. patent application Ser. No. 12/126,776, filed 23 May 2008, which application is incorporated herein by reference. Alternatively, systems and methods of the invention are adaptable to desalinate water containing alkaline earth metals as described, for example, in commonly assigned U.S. patent application Ser. No. 12/163,205, filed 27 Jun. 2008, which application is incorporated herein by reference. In yet another embodiment, at least a portion of the recirculating solution is diluted and pumped to an ocean depth or reservoir depth at which the temperature and pressure are sufficient to keep the CO₂ in solution.

Thus, by using methods and systems comprising recirculation as described herein, water and additives required to process carbon dioxide may be conserved.

### DRAWINGS

The novel features of the invention are set forth with particularity in the appended claims. A better understanding of the features and advantages of the invention will be obtained by reference to the following detailed description that sets forth illustrative embodiments, in which the principles of the invention are utilized, and the accompanying drawings of which:

FIG. 1A provides a system for processing carbon dioxide.

FIG. 1B provides a system for processing carbon dioxide, wherein the system is configured for recirculation.

FIG. 1C provides a system for processing carbon dioxide, wherein the system is configured for recirculation, and wherein the system is configured with an electrochemical system for producing proton-removing agents.

FIG. 2 provides a system for processing carbon dioxide, wherein the system is configured for recirculation, and wherein the systems comprises primary and secondary dewatering systems.

FIG. 3 provides a filtration unit of the invention.

FIG. 4 provides a system for processing carbon dioxide, wherein the system comprises at least one filtration unit and an optional electrochemical system.

FIG. 5 provides a system for processing carbon dioxide, wherein the system is configured for recirculation, and wherein the system comprises a filtration system comprising at least one filtration unit and an electrochemical system.

FIG. 6 provides a system for processing carbon dioxide, wherein the system is configured for recirculation, and wherein the system comprises a filtration system comprising at least two filtration units and an optional electrochemical system.

FIG. 7 provides a system for processing carbon dioxide, wherein the system is configured for recirculation, and wherein the system comprises a filtration system comprising at least two filtration units and an electrochemical system.

FIG. 8 provides a system for processing carbon dioxide, wherein the system is configured for recirculation, and wherein the system comprises a filtration system comprising at least three filtration units and an electrochemical system.

FIG. 9 provides a system for processing carbon dioxide, wherein the system is configured for recirculation, and wherein the system comprises at least one filtration unit and an optional electrochemical system.

FIG. 10 provides a system for processing carbon dioxide, wherein the system is configured for recirculation, and wherein the system comprises at least one filtration unit and an electrochemical system.

FIG. 11 provides a system for processing carbon dioxide, wherein the system is configured for recirculation, and wherein the system comprises a filtration system comprising at least two filtration units and an electrochemical system.

FIG. 12 provides a system for processing carbon dioxide, wherein the system is configured for recirculation, wherein the system comprises a treatment system comprising a filtration system and a dewatering, and an electrochemical system.

### DESCRIPTION

Before the invention is described in greater detail, it is to be understood that the invention is not limited to particular embodiments described herein as such embodiments may vary. It is also to be understood that the terminology used herein is for the purpose of describing particular embodiments only, and is not intended to be limiting, since the scope of the invention will be limited only by the appended claims. Unless defined otherwise, all technical and scientific terms used herein have the same meaning as commonly understood by one of ordinary skill in the art to which this invention belongs.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number, which, in the context in which it is presented, provides the substantial equivalent of the specifically recited number.

All publications, patents, and patent applications cited in this specification are incorporated herein by reference to the same extent as if each individual publication, patent, or patent application were specifically and individually indicated to be incorporated by reference. Furthermore, each cited publication, patent, or patent application is incorporated herein by reference to disclose and describe the subject matter in connection with which the publications are cited. The citation of any publication is for its disclosure prior to the filing date and should not be construed as an admission that the invention described herein is not entitled to antedate such publication by virtue of prior invention. Further, the dates of publication provided might be different from the actual publication dates, which may need to be independently confirmed.

It is noted that, as used herein and in the appended claims, the singular forms “a,” “an,” and “the” include plural references unless the context clearly dictates otherwise. It is further noted that the claims may be drafted to exclude any optional element. As such, this statement is intended to serve as antecedent basis for use of such exclusive terminology as “solely,” “only,” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the invention. Any recited method may be carried out in the order of events recited or in any other order, which is logically possible. Although any methods and materials similar or equivalent to those described herein may also be used in the practice or testing of the invention, representative illustrative methods and materials are now described.

As described above, reducing potential risks of climate change will require sequestration or sequestration and avoidance of carbon dioxide from various anthropogenic processes. As such, systems and methods for processing carbon dioxide comprise sequestering carbon dioxide or sequestering and avoiding carbon dioxide are provided.

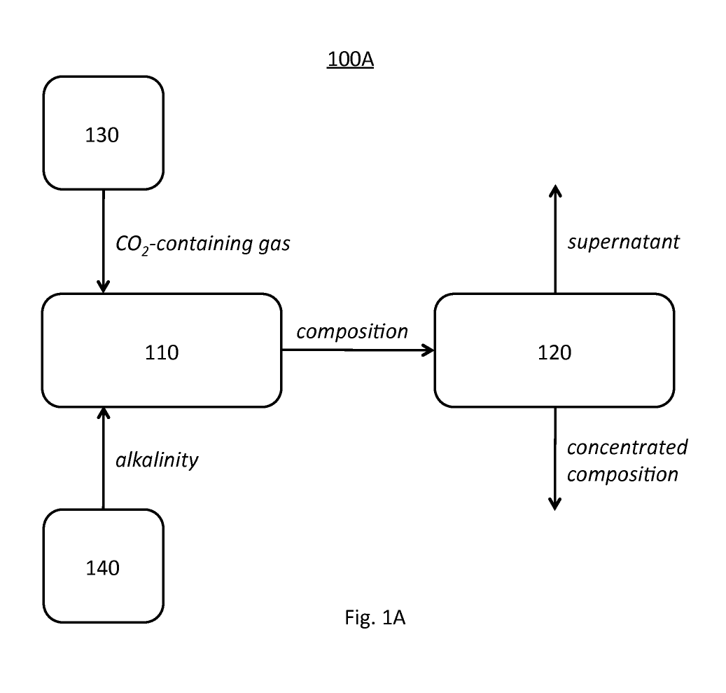

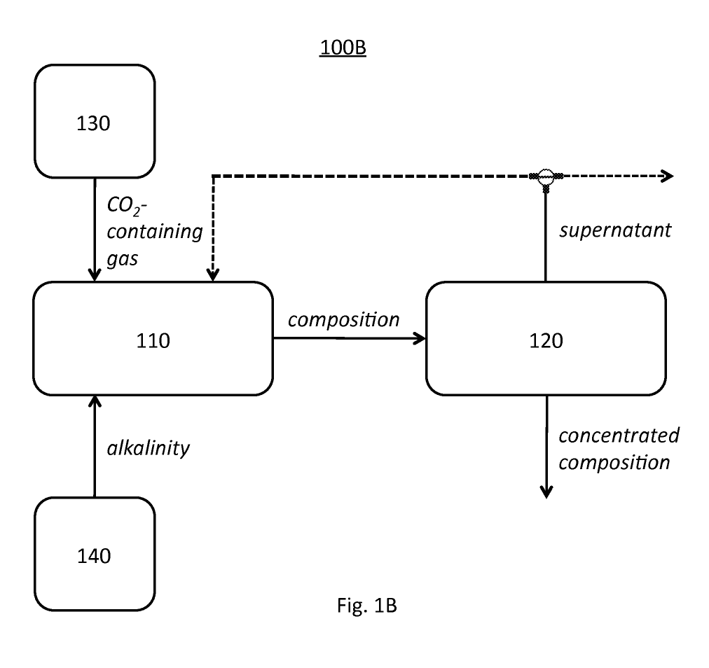

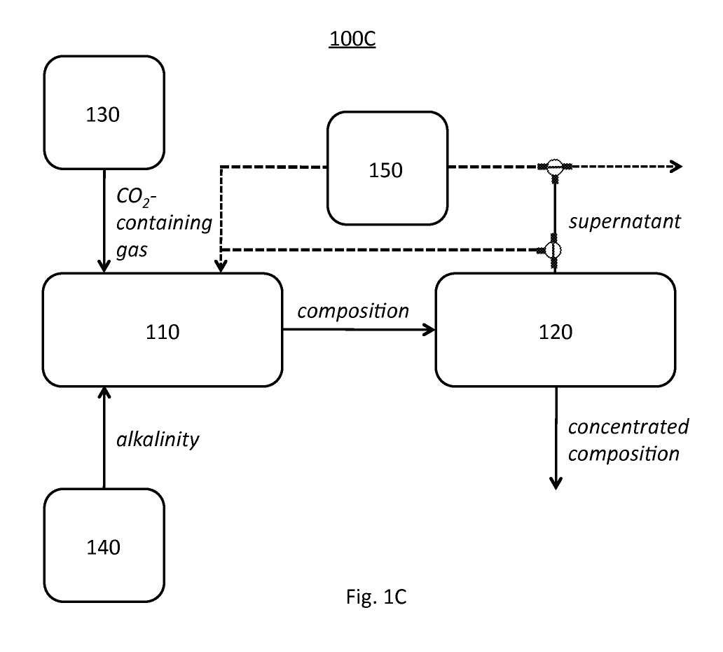

In some embodiments, the invention provides a system for processing carbon dioxide as shown in FIG. 1A, wherein the system comprises a processor (110) and a treatment system (120) configured to process carbon dioxide from a source of carbon dioxide (130) using a source of alkalinity (140). As described in further detail below, the processor may comprise a contactor such as a gas-liquid or a gas-liquid-solid contactor, wherein the contactor is configured for charging a solution or slurry with carbon dioxide to produce a carbon dioxide-charged solution or slurry. In some embodiments, the contactor is configured to produce compositions from the carbon dioxide or solvated forms thereof, wherein the compositions comprise carbonates, bicarbonate, or carbonates and bicarbonates. In some embodiments, the processor may further comprise a reactor configured to produce compositions comprising carbonates, bicarbonates, or carbonates and bicarbonates from the carbon dioxide or solvated forms thereof. In some embodiments, the processor may further comprise a settling tank configured for settling compositions comprising precipitation material comprising carbonates, bicarbonates, or carbonates and bicarbonates. As described in further detail below, the treatment system may comprise a dewatering system configured to concentrate compositions comprising carbonates, bicarbonates, or carbonates and bicarbonates. The treatment system may further comprise a filtration system, wherein the filtration system comprises at least one filtration unit configured for filtration of supernatant from the dewatering system, filtration of the composition from the processor, or a combination thereof. As shown in FIG. 1B and described in further detail below, systems of the invention may be further configured to recirculate at least a portion of the supernatant from the treatment system. The source of carbon dioxide, as described below, may be any of a variety of industrial sources of carbon dioxide, including, but not limited to coal-fired power plants and cement plants. The source of alkalinity, also described in further detail below, may be from any of a variety of sources of alkalinity, including, but not limited to seawater, brines, and freshwater with added minerals. In some embodiments, the system further comprises a source of divalent cations such as those of alkaline earth metals (e.g., Ca²⁺, Mg²⁺). In such embodiments, the source of divalent cations may be operably connected to the source of alkalinity or directly to the processor.

In some embodiments, the invention provides a system for processing carbon dioxide as shown in FIG. 1B,

wherein the system comprises a processor (110) and a treatment system (120) configured to process carbon dioxide from a source of carbon dioxide (130) using a source of alkalinity (140), and further wherein the processor and the treatment system are operably connected for recirculating at least a portion of treatment system supernatant. As described herein, the treatment system of such carbon dioxide-processing systems may comprise a dewatering system and a filtration system. As such, the dewatering system, the filtration system, or a combination of the dewatering system and the filtration system may be configured to provide at least a portion of supernatant to the processor for processing carbon dioxide. Although not shown in FIG. 1B, the treatment system may also be configured to provide at least a portion of supernatant to a washing system configured to wash compositions of the invention, wherein the compositions comprise precipitation material (e.g., CaCO₃, MgCO₃). The processor of carbon dioxide-processing systems of the invention may be configured to receive treatment system supernatant in a contactor (e.g., gas-liquid contactor, gas-liquid-solid contactor), a reactor, a combination of the contactor and the reactor, or in any other unit or combination of units in the processor. In some embodiments, the carbon dioxide-processing system is configured to provide at least a portion of the supernatant to a system or process external to the carbon-dioxide processing system. For example, a system of the invention may be operably connected to a desalination plant such that the system provides at least a portion of treatment system supernatant to the desalination plant for desalination.

In some embodiments, the invention provides a system for processing carbon dioxide as shown in FIG. 1C,

wherein the system comprises a processor (110) and a treatment system (120) configured to process carbon dioxide from a source of carbon dioxide (130) using a source of alkalinity (140), and wherein the system further comprises an electrochemical system (150), and further wherein the processor, the treatment system, and the electrochemical system are operably connected for recirculating at least a portion of treatment system supernatant. As described above in reference to the treatment system of FIG. 1B, the dewatering system, the filtration system, or a combination of the dewatering system and the filtration system may be configured to provide at least a portion of treatment system supernatant to the processor for processing carbon dioxide. The treatment system may also be configured to provide at least a portion of the treatment system supernatant to the electrochemical system, wherein the electrochemical system, as described in more detail below, is configured to produce proton-removing agents or effect proton removal. As described in reference to FIG. 1B, the treatment system may also be configured to provide at least a portion of supernatant to a washing system configured to wash compositions of the invention, wherein the compositions comprise precipitation material (e.g., CaCO₃, MgCO₃). The processor of carbon dioxide-processing systems of the invention may be configured to receive treatment system supernatant or an electrochemical system stream in a contactor (e.g., gas-liquid contactor, gas-liquid-solid contactor), a reactor, a combination of the contactor and the reactor, or in any other unit or combination of units in the processor. In some embodiments, the carbon dioxide-processing system may be configured to provide at least a portion of the supernatant to a system (e.g., desalination plant) or process (e.g., desalination) external to the carbon-dioxide processing system.

In reference to FIGS. 1A-1C, the invention provides methods of processing an industrial source of carbon dioxide (130) and producing a composition comprising carbonates, bicarbonates, or carbonates and bicarbonates. In such embodiments, the industrial source of carbon dioxide may be sourced, a source of alkalinity (140) may be sourced, and each may be provided to processor 110 to be processed (i.e., subjected to suitable conditions for production of the composition comprising carbonates, bicarbonates, or carbonates and bicarbonates). In some embodiments, processing the industrial source of carbon dioxide comprises contacting the source of alkalinity in a contactor such as, but not limited to, a gas-liquid contactor or a gas-liquid-solid contactor to produce a carbon dioxide-charged solution or slurry. In some embodiments, the composition comprising carbonates, bicarbonates, or carbonates and bicarbonates may be produced from the carbon dioxide-charged solution or slurry in the contactor. In some embodiments, the carbon dioxide-charged solution or slurry may be provided to a reactor, within which the composition comprising carbonates, bicarbonates, or carbonates and bicarbonates may be produced. In some embodiments, the composition is produced in both the contactor and the reactor. For example, in some embodiments, the contactor may produce an initial composition comprising bicarbonates and the reactor may produce the composition comprising carbonates, bicarbonates, or carbonates and bicarbonates from the initial composition. In some embodiments, methods of the invention may further comprise sourcing a source of divalent cations such as those of alkaline earth metals (e.g., Ca²⁺, Mg²⁺). In such embodiments, the source of divalent cations may be provided to the source of alkalinity or provided directly to the processor. Provided sufficient divalent cations are provided by the source of alkalinity, by the source of divalent cations, or by a combination of the foregoing sources, the composition comprising carbonates, bicarbonates, or carbonates and bicarbonates may comprise an isolable precipitation material (e.g., CaCO₃, MgCO₃). The precipitation material-containing composition from the contactor or reactor may be provided to a settling tank, and, subsequently, to a treatment system of the invention. In some embodiments, the composition may be provided directly to the treatment system without being provided to a settling tank. For example, a composition of the invention that does not contain an isolable precipitation material may be provided directly to the treatment system; however, a composition of the invention comprising an isolable precipitation material may also be provided directly to the treatment system. As described in additional detail below, the composition may be provided to any of a number of treatment system sub-systems including, but not limited to a dewatering system, a filtration system, or a dewatering system followed by a filtration system, wherein the treatment system, or a sub-system thereof, separates a supernatant from the composition and produces a concentrated composition (e.g., the concentrated composition is more concentrated with to respect to carbonates, bicarbonates, or carbonates and carbonates).

With reference to FIGS. 1B and 1C, the invention also provides methods of processing an industrial source of carbon dioxide (130) and producing a composition comprising carbonates, bicarbonates, or carbonates and bicarbonates, wherein at least a portion of treatment system supernatant is recirculated. As shown in FIGS. 1B and 1C, supernatant from the treatment system, which may comprise a dewatering system and a filtration system, may be recirculated in a variety of ways. As such, in some embodiments, at least a portion of the supernatant from the dewatering system, the filtration system, or a combination of the dewatering system and the filtration system may be used to process carbon dioxide. The supernatant may be provided to a carbon dioxide-processing system processor. In such embodiments, the supernatant may be provided to a contactor (e.g., gas-liquid contactor, gas-liquid-solid contactor), to a reactor, to a combination of the contactor and the reactor, or to any other unit or combination of units for processing carbon dioxide. In addition, in some embodiments, at least a portion of the supernatant from the treatment system may be provided to a washing system. In such embodiments, the supernatant may be used to wash compositions (e.g., precipitation material comprising CaCO₃ and/or MgCO₃) of the invention. For example, the supernatant may be used to wash chloride from carbonate-based precipitation material. With reference to FIG. 1C, at least a portion of the treatment system supernatant may be provided to an electrochemical system. As such, treatment system supernatant may be used to produce proton-removing agents or effect proton removal for processing carbon dioxide. In some embodiments, at least a portion of the supernatant from the treatment system may be provided to a different system or process. For example, at least a portion of the treatment system supernatant may be provided to a desalination plant or desalination process such that the treatment system supernatant, which is generally softer (i.e., lower concentration of Ca²⁺ and/or Mg²⁺) than other available feeds (e.g., seawater, brine, etc.) after being used to process carbon dioxide, may be desalinated for potable water.

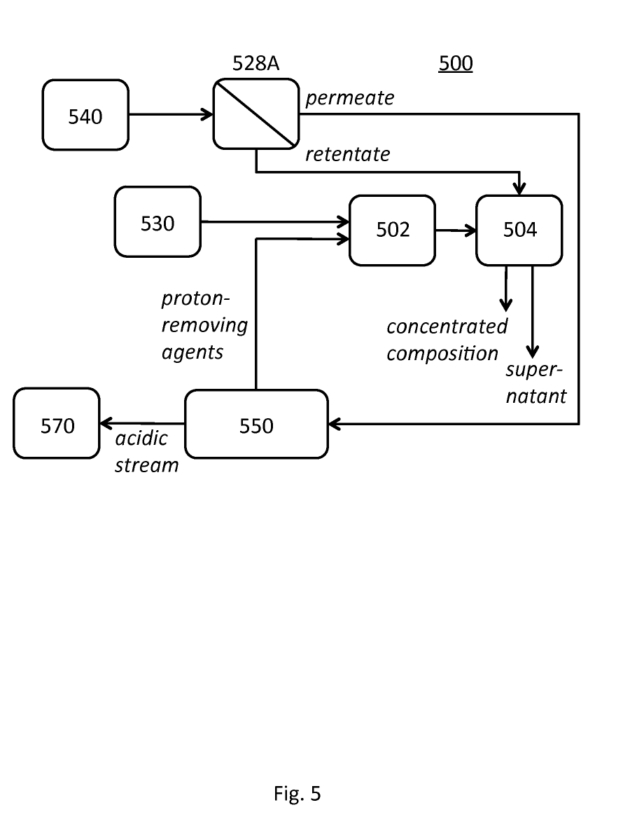

Recirculation of treatment system supernatant is advantageous as recirculation provides efficient use of available resources; minimal disturbance of surrounding environments; and reduced energy requirements, which reduced energy requirements provide for lower carbon footprints for systems and methods of the invention. When a carbon dioxide-processing system of the invention is operably connected to an industrial plant (e.g., fossil fuel-fired power plant such as coal-fired power plant) and utilizes power generated at the industrial plant, reduced energy requirements provided by recirculation of treatment system supernatant provide for a reduced parasitic load on the industrial plant. A carbon dioxide-processing system not configured for recirculation (i.e., a carbon-dioxide processing system configured for a once-through process) such as that shown in FIG. 1A, may have a parasitic load on the industrial plant of at least 10% attributable to continuously pumping a fresh source of alkalinity (e.g., seawater, brine) into the system. In such an example, a 100 MW power plant (e.g., a coal-fired power plant) would need to devote 10 MW of power to the carbon dioxide-processing system for continuously pumping a fresh source of alkalinity into the system. In contrast, a system configured for recirculation such as that shown in FIG. 1B or FIG. 1C may have a parasitic load on the industrial plant of less than 10%, such as less than 8%, including less than 6%, for example, less than 4% or less than 2%, which parasitic load may be attributable to pumping make-up water and recirculating supernatant. Carbon dioxide-processing systems configured for recirculation, may, when compared to systems designed for a once-through process, exhibit a reduction in parasitic load of at least 2%, such as at least 5%, including at least 10%, for example at least 25% or at least 50%. For example, if a carbon dioxide-processing system configured for recirculation consumes 9 MW of power for pumping make-up water and recirculating supernatant and a carbon dioxide-processing system designed for a once-through process consumes 10 MW attributable to pumping, then the carbon dioxide-processing system configured for recirculation exhibits a 10% reduction in parasitic load. For systems such as those shown in FIGS. 1B and 1C (i.e., carbon dioxide-processing systems configured for recirculation), the reduction in the parasitic load attributable to pumping and recirculating may also provide a reduction in total parasitic load, especially when compared to carbon dioxide-processing systems configured for once-through process. In some embodiments, recirculation provides a reduction in total parasitic load of a carbon dioxide-processing system, wherein the reduction is at least 2%, such as at least 4%, including at least 6%, for example at least 8% or at least 10% when compared to total parasitic load of a carbon dioxide-processing system configured for once-through process. For example, if a carbon dioxide-processing system configured for recirculation has a 15% parasitic load and a carbon dioxide-processing system designed for a once-through process has a 20% parasitic load, then the carbon dioxide-processing system configured for recirculation exhibits a 5% reduction in total parasitic load. For example, a carbon dioxide-processing system configured for recirculation, wherein recirculation comprises filtration through a filtration unit (e.g., FIG. 5) such as a nanofiltration unit, may have a reduction in total parasitic load of at least 2%, such as at least 4%, including at least 6%, for example at least 8% or at least 10% when compared to a carbon dioxide-processing system configured for once-through process.

The parasitic load of carbon dioxide-processing systems of the invention may be further reduced by efficient use of other resources. In some embodiments, the parasitic load of carbon dioxide-processing systems of the invention may be further reduced by efficient use of heat from an industrial source. In some embodiments, for example, heat from the industrial source of carbon dioxide (e.g., flue gas heat from a coal-fired power plant) may be utilized for drying a composition comprising precipitation material comprising carbonates, bicarbonates, or carbonates and bicarbonates. In such embodiments, a spray dryer may be used for spray drying the composition. For example, low-grade (e.g., 150-200° C.) waste heat may be utilized by means of a heat exchanger to evaporatively spray dry the composition comprising the precipitation material. In addition, utilizing heat from the industrial source of carbon dioxide for drying compositions of the invention allows for simultaneous cooling of the industrial source of carbon dioxide (e.g., flue gas from a coal-fired power plan), which enhances dissolution of carbon dioxide, a process which is inversely related to temperature. In some embodiments, the parasitic load of carbon dioxide-processing systems of the invention may be further reduced by efficient use of pressure. For example, in some embodiments, carbon dioxide-processing systems of the invention are configured with an energy recovery system. Such energy recovery systems are known, for example, in the art of desalination and operate by means of pressure exchange. In some embodiments, the overall parasitic load of the carbon dioxide-processing system is less than 20%, such as less than 15%, including less than 10%, for example, less than 5% or less than 3% when capturing and processing 70-90% of the carbon dioxide emitted from an industrial plant (e.g., coal-fired power plant). As such, carbon dioxide-processing systems of the invention configured for recirculation, heat exchange, and/or pressure exchange may reduce the parasitic load on power-providing industrial plants while maintaining carbon dioxide processing capacity.

In addition to recirculation, parasitic load of carbon dioxide-processing systems may be further reduced by other means. A person having ordinary skill in the art will appreciate that flow rates, mass transfer, and heat transfer may vary and may be optimized for systems and methods described herein, and that parasitic load on a power plant may be reduced while carbon dioxide processing is maximized. Precise control over reaction conditions may be used to maximize production and quality of compositions of the invention (e.g., precipitation material and related products) while minimizing material and energy inputs. For example, in some embodiments, feed rates may be adjusted such that alkalinity, divalent cations, and/or proton-removing agents are optimally consumed as they are provided to the process. Other parameters that may be controlled include, but are not limited to, rate of introduction of gaseous waste comprising carbon dioxide, reaction time, temperature, pH, type of alkalinity (e.g., HCO₃⁻; CO₃²⁻; B(OH)₄⁻; OH⁻; PO₄³⁻; HPO₄²⁻; SiO(OH)³⁻; or combinations thereof), type of divalent cations (e.g., Ca²⁺, Mg²⁺), ratio of divalent cations, divalent cation concentration, precipitation conditions, dewatering conditions, drying conditions, and the like. Precise control over reaction conditions may also be used to control chemical content and morphology of the resultant product, particularly precipitation material (e.g., CaCO₃, MgCO₃, or combinations thereof). For example, control over reaction conditions may allow for formation of metastable, amorphous polymorphs of certain carbonates, which carbonates may be suitable for both cementitious materials (e.g., supplementary cementitious materials) and precursors of aggregate. Use of proton-removing agents (e.g., NaOH) produced in electrochemical systems of the invention in conjunction with high salinity water (e.g., seawater, brines, high alkalinity brines, dissolved minerals, etc.), for example, enables a high level of control over the carbonate species formed and the morphology of that carbonate species. Lastly, precise pH control over the process not only minimizes energy costs, but also prevents release of carbon dioxide, for example, during conversion of bicarbonate to carbonate.

Inevitably, methods described herein consume water as water may become part of a composition of the invention (e.g., precipitation material comprising, for example, amorphous calcium carbonate CaCO₃.H₂O; nesquehonite MgCO₃.2H₂O; etc.), may be vaporized by drying (e.g., spray drying) compositions of the invention, or lost in some other part of the process. As such, make-up water may be provided to account for water lost to processing carbon dioxide to produce compositions of the invention (e.g., spray-dried precipitation material). For example, make-up water amounting to less than 700,000 gallons per day may replace water lost to producing, for example, spray-dried precipitation material from flue gas from a 35 MWₑ coal-fired power plant. Processes requiring only make-up water may be considered zero process water discharge processes. In processes in which additional water other than make-up water is used, that water may be sourced from any of the water sources described herein. In some embodiments, for example, water may be sourced from the power plant cooling stream and returned to that stream in a closed loop system. Processes requiring make-up water and additional process water are considered low process water discharge processes because systems and methods of the invention are designed to efficiently use resources.

Dewatering is the process of separating effluent liquid from solid material resulting from the processes previously described herein. Generally, dewatering is considered to take place in two or more steps. The first step is termed primary dewatering in which the original composition comprising carbonates, bicarbonates, or carbonates and bicarbonates is concentrated such that it comprises up to 50% (w/w) solids. The subsequent step or steps may bring the composition to greater than 90% (w/w) solids. In the case where there is only a second step, that is termed secondary dewatering. Methods employed in primary dewatering typically involve physical separation of the solids from the solution. Exemplary apparatus used in primary dewatering include, but are not limited to: settling tanks, filter presses, belt presses, vacuum drums, hydrocyclones, centrifuges, and clarifiers (e.g. Epuramat clarifier). Methods employed in subsequent dewatering, such as secondary dewatering, typically involve evaporative techniques. That is to say that the methods allow for the evaporation of solution from the composition comprising carbonates, bicarbonates, or carbonates and bicarbonates with the application of heat or sufficient air passing over the mixture to cause an increase in solids in the remaining portion of the mixture. Methods employed in secondary dewatering include, but are not limited to: spray drying, contacting the composition with a heat exchanger using waste heat, direct heating of the mixture with hot flue gas, exposing the mixture to ambient heat in evaporation ponds, and the use of systems commonly used in irrigation or snow making to disperse the mixture into the air and allow for evaporation using the ambient heat of the air. In some cases, it is desirable to remove sub-micrometer particulates from water vapor created in the practice of a process. In such cases, an exemplary device to use would be a wet electrostatic precipitator.

In some embodiments, the systems of the invention further comprise primary dewatering system or apparatus. In some embodiments, systems of the invention comprise primary dewatering systems or apparatus such as, but not limited to: Epuramat's Extrem-Separator (“ExSep”) liquid-solid separator, Xerox PARC's spiral concentrator, a settling tank, a filter press, a belt press, a vacuum drum, a hydrocyclone, a centrifuge, a clarifier, a lamellar settling tank, a conveyor belt that shakes water or other solution free from, for example, solids in a mixture or slurry, or any combination thereof. In some embodiments, systems of the invention comprise multiple primary dewatering system or apparatus used either in series or parallel or both. In some embodiments, the primary dewatering system or apparatus used in systems of the invention are connected to the other portions of the systems through means such as, but not limited to: a baffle, a spiral channel, a conduit, a screw conveyor, a conveyor belt, a conduit and pump system, an inclined conduit, a series of discrete containers, or any combination thereof. In some embodiments, the primary dewatering system or apparatus is configured to bring the composition comprising carbonates, bicarbonates, or carbonates and bicarbonates to between 5 and 50% (w/w) solids. In some embodiments, the primary dewatering system or apparatus is configured to bring the composition to between 5 and 45% (w/w) solids; such as between 10 and 40% (w/w) solids; such as between 15 and 35% (w/w) solids; such as between 20 and 30% (w/w) solids. In some embodiments, the primary dewatering system or apparatus is configured to bring the composition to between 5 and 40% (w/w) solids. In some embodiments, the primary dewatering system or apparatus is configured to provide supernatant to the processor for contact with the industrial source of carbon dioxide. In such embodiments, the solution (e.g., alkaline solution comprising supernatant) for contact with the industrial source of carbon dioxide may comprise at least 10% primary dewatering supernatant, such as at least 25% primary dewatering supernatant, including at least 50% primary dewatering supernatant, for example at least 75% or at least 85% primary dewatering supernatant. In some embodiments, the solution for contact with the industrial source of carbon dioxide may comprise at least 95% primary dewatering supernatant. In some embodiments, the solution for contact with the industrial source of carbon dioxide may comprise between 10% and 25%, 25% and 50%, 50% and 75%, or 75% and 95% primary dewatering supernatant.

In some embodiments, the systems of the invention further comprise secondary dewatering system or apparatus. In some embodiments, systems of the invention comprise multiple secondary dewatering systems or apparatus used either in series or parallel or both. In some embodiments, systems of the invention comprise a secondary dewatering system or apparatus such as, but not limited to: spray dryers; commonly used irrigation apparatus; snow making machinery; furnaces; ovens; apparatus that expose the composition to waste heat while moving the mixture or slurry (e.g. a screw conveyor that allows for intimate mixing of the mixture or slurry with hot waste gas from an industrial process); apparatus that employ waste heat through heat exchangers to cause water evaporation from the composition; evaporation pools or ponds; or any combination thereof. In some embodiments, the secondary dewatering system or apparatus used in systems of the invention is connected to the other portions of the system through means such as, but not limited to: a baffle, a spiral channel, a conduit, a screw conveyor, a conveyor belt, a conduit and pump system, an inclined conduit, a series of discrete containers, or any combination thereof. In some embodiments, the secondary dewatering system or apparatus is configured to bring the composition comprising carbonates, bicarbonates, or carbonates and bicarbonates to greater than 40% (w/w) solids. In some embodiments, the secondary dewatering system or apparatus is configured to bring the composition to between 40 and 99% (w/w) solids. In some embodiments, the secondary dewatering system or apparatus is configured to bring the composition to between 45 and 95% (w/w) solids; such as between 45 and 90% (w/w) solids; such as between 50 and 90% (w/w) solids; such as between 50 and 85% (w/w) solids; such as between 55 and 85% (w/w) solids; such as between 60 and 85% (w/w) solids; such as between 60 and 80% (w/w) solids; such as between 65 and 80% (w/w) solids; such as between 65 and 75% (w/w) solids. In some embodiments, the secondary dewatering system or apparatus is configured to bring the composition to greater than 75% (w/w) solids; such as greater than 80% (w/w) solids; such as greater than 85% (w/w) solids; such as greater than 90% (w/w) solids; such as greater than 95% (w/w) solids. In some embodiments, the secondary dewatering system or apparatus is configured to bring the composition to greater than 99% (w/w) solids. In some embodiments, the secondary dewatering system or apparatus is configured to provide supernatant to the processor for contact with the industrial source of carbon dioxide. In such embodiments, the solution (e.g., alkaline solution comprising supernatant) for contact with the industrial source of carbon dioxide may comprise at least 10% secondary dewatering supernatant, such as at least 25% secondary dewatering supernatant, including at least 50% secondary dewatering supernatant, for example at least 75% or at least 85% secondary dewatering supernatant. In some embodiments, the solution for contact with the industrial source of carbon dioxide may comprise at least 95% secondary dewatering supernatant. In some embodiments, the solution for contact with the industrial source of carbon dioxide may comprise between 10% and 25%, 25% and 50%, 50% and 75%, or 75% and 95% secondary dewatering supernatant.

In some embodiments, methods of the invention may further comprise a primary dewatering step. In some embodiments, methods of the invention comprise a primary dewatering step that utilizes one or more apparatus, such as, but not limited to: Epuramat's Extrem-Separator (“ExSep”) liquid-solid separator, Xerox PARC's spiral concentrator, a settling tank, a filter press, a belt press, a vacuum drum, a hydrocyclone, a centrifuge, a clarifier, a lamellar settling tank, a conveyor belt that shakes water or other solution free from solids in a mixture or slurry, or any combination thereof. In some embodiments, methods of the invention comprise a primary dewatering step that utilizes multiple dewatering apparatus, for example of the type listed previously herein, either in series or in parallel. In some embodiments, the primary step brings the composition comprising carbonates, bicarbonates, or carbonates and bicarbonates to between 5 and 50% (w/w) solids. In some embodiments, the primary dewatering step brings the composition to between 5 and 45% (w/w) solids; such as between 10 and 40% (w/w) solids; such as between 15 and 35% (w/w) solids; such as between 20 and 30% (w/w) solids. In some embodiments, the primary step brings the composition to between 5 and 40% (w/w) solids.

In some embodiments, methods of the invention may further comprise a secondary dewatering step. In some embodiments, multiple secondary dewatering steps may be employed. In some embodiments, methods of the invention comprise a secondary dewatering step that utilizes one or more apparatus, such as, but not limited to: spray dryers; commonly used irrigation apparatus; snow making machinery; furnaces; ovens; apparatus that expose the mixture or slurry to waste heat while moving the composition comprising carbonates, bicarbonates, or carbonates and bicarbonates (e.g. a screw conveyor that allows for intimate mixing of the composition with hot waste gas from an industrial process); apparatus that employ waste heat through heat exchangers to cause evaporation from the composition; evaporation pools or ponds; or any combination thereof. In some embodiments, methods of the invention comprise a secondary dewatering step that utilizes multiple dewatering apparatus, for example of the type listed previously herein, either in series or in parallel. In some embodiments, the secondary dewatering step brings the composition comprising carbonates, bicarbonates, or carbonates and bicarbonates to greater than 40% (w/w) solids. In some embodiments, the secondary dewatering step brings the composition to between 40 and 99% (w/w) solids. In some embodiments, the secondary dewatering step brings the composition to between 45 and 95% (w/w) solids; such as between 45 and 90% (w/w) solids; such as between 50 and 90% (w/w) solids; such as between 50 and 85% (w/w) solids; such as between 55 and 85% (w/w) solids; such as between 60 and 85% (w/w) solids; such as between 60 and 80% (w/w) solids; such as between 65 and 80% (w/w) solids; such as between 65 and 75% (w/w) solids. In some embodiments, the secondary dewatering step brings the composition to greater than 75% (w/w) solids; such as greater than 80% (w/w) solids; such as greater than 85% (w/w) solids; such as greater than 90% (w/w) solids; such as greater than 95% (w/w) solids. In some embodiments, the secondary dewatering step brings the composition to greater than 99% (w/w) solids.

In some embodiments, a dewatering system comprising a primary dewatering system and a secondary dewatering system may be configured to bring a composition comprising carbonates, bicarbonates, or carbonates and bicarbonates to between 40 and 99% (w/w) solids. In some embodiments, the dewatering system is configured to bring the composition to between 45 and 95% (w/w) solids; such as between 45 and 90% (w/w) solids; such as between 50 and 90% (w/w) solids; such as between 50 and 85% (w/w) solids; such as between 55 and 85% (w/w) solids; such as between 60 and 85% (w/w) solids; such as between 60 and 80% (w/w) solids; such as between 65 and 80% (w/w) solids; such as between 65 and 75% (w/w) solids. In some embodiments, the dewatering system is configured to bring the composition to greater than 75% (w/w) solids; such as greater than 80% (w/w) solids; such as greater than 85% (w/w) solids; such as greater than 90% (w/w) solids; such as greater than 95% (w/w) solids. In some embodiments, the dewatering system is configured to bring the composition to greater than 99% (w/w) solids. In some embodiments, a dewatering system comprising a primary dewatering system and a secondary dewatering system is configured to provide supernatant to the processor for contact with the industrial source of carbon dioxide. In such embodiments, the solution (e.g., alkaline solution comprising supernatant) for contact with the industrial source of carbon dioxide may comprise at least 10% dewatering system supernatant, such as at least 25% dewatering system supernatant, including at least 50% dewatering system supernatant, for example at least 75% or at least 85% dewatering system supernatant. In some embodiments, the solution for contact with the industrial source of carbon dioxide may comprise at least 95% dewatering system supernatant. In some embodiments, the solution for contact with the industrial source of carbon dioxide may comprise between 10% and 25%, 25% and 50%, 50% and 75%, or 75% and 95% dewatering system supernatant.

As discussed above, treatment system supernatant may be recirculated for reuse in a processor of a carbon dioxide-processing system or a sub-system of the processor (e.g., gas-liquid contactor, gas-liquid-solid contactor, reactor, etc.). To effect reuse of treatment system supernatant (e.g., dewatering system supernatant), a filtration system comprising at least one filtration unit may be used. In some embodiments, the filtration system comprises an ultrafiltration unit, a nanofiltration unit, a reverse osmosis unit, or a combination of the foregoing units. Filtration units of the invention (e.g., nanofiltration units, reverse osmosis units) may be used, in some embodiments, for example, to increase the concentration of multivalent ions (e.g., divalent cations such as Ca²⁺, Mg²⁺) for processing carbon dioxide, to decrease the concentration of monovalent ions (e.g., Cl⁻, Na⁺) in compositions, to provide substantially pure water for electrochemical systems and processes, to provide substantially pure water for washing compositions (e.g., precipitation material comprising carbonates, bicarbonates, or carbonates and bicarbonates) of the invention, to provide substantially pure electrolyte comprising NaCl for electrochemical systems and processes, to recover proton-removing agents (e.g., OH⁻) for processing carbon dioxide, or to recover unreacted multivalent cations (e.g., divalent cation such as Ca²⁺, Mg²⁺) and/or alkalinity (e.g., bicarbonates, etc.) from processing carbon dioxide. Other suitable uses or combinations of the foregoing uses are also possible.

Filtration units such as reverse osmosis units and nanofiltration units may be characterized by membranes (e.g., semi-permeable membranes) used to separate various ions (e.g., divalent cations, monovalent anions). Any suitable membrane to effect a desired separation may be used. The membranes are generally thin-film composites assembled from different layers of porosity, starting with a fibrous backing, a polysulfone support layer, and a polyamide filtration layer; however, some membranes may be cellulose acetate (e.g., diacetate or triacetate grades, or mixtures thereof). The membranes reject or allow ions based on a number of different factors including solute, charge, size, and shape. Percent recovery may be calculated from the ratio of permeate flow to feed flow (e.g., percent recovery=permeate flow/feed flow×100). Percent rejection is calculated in accordance with the following equation,

percent rejection=1−(permeate TDS/feed TDS)

wherein “TDS” is total dissolved solids. Concentration factor (e.g., divalent cation concentration factor) is calculated for a desired genus or species of ion from a ratio of concentration ratio in the retentate to the feed (e.g., divalent cation (“DVC”) concentration factor=[DVC]retentate/[DVC]feed).

Nanofiltration may be casually described as a “loose” variety of reverse osmosis; in other words, nanofiltration membranes pass more solute and operate at a lower osmotic pressure than reverse osmosis membranes. In some embodiments, membranes that selectively reject multivalent ions (e.g., divalent cations such as Ca²⁺ and/or Mg²⁺) and pass monovalent ions (e.g., Cl⁻) may be used for concentrating divalent ions in retentate. Nanofiltration membranes useful in some embodiments of the invention include membranes from Koch (e.g., SR-100) and Dow (e.g., FilmTec NF245). The higher the percent recovery, the more concentrated the retentate may be in multivalent ions. As above, recovery may be calculated from the ratio of permeate flow to feed flow. As such, higher recovery means a smaller retentate stream. Percentage recovery may be higher for nanofiltration than for reverse osmosis due to the difference in total dissolved solids (TDS) between the retentate and the source of alkalinity or dewatering system supernatant. Typically, the difference in TDS is much lower at a given recovery for nanofiltration than for reverse osmosis.

By way of example, assuming no divalent cations pass through a nanofiltration membrane, the concentration factor for divalent cations at 75% recovery is 3. As such, retentate comprising rejected divalent cations has ¾ less water than the source of alkalinity of dewatering supernatant. In another example, at 80% recovery, the concentration factor is 4. It should be noted that high divalent cation concentration in the retentate might cause fouling of the nanofiltration unit membrane and limit the percent recovery.

As above, dewatering system supernatant comprising multivalent ions (e.g., divalent cations such as Ca²⁺ and/or Mg²⁺) may be provided to the processor. In some embodiments, dewatering system supernatant may be provided to a filtration system comprising at least one filtration unit, for example, a nanofiltration unit, in which the dewatering system supernatant is concentrated to provide a concentrated source of multivalent ions (e.g., divalent cations such as Ca²⁺ and/or Mg²⁺) for reuse in processing carbon dioxide. In such embodiments, the filtration unit comprises a membrane, for example, a nanofiltration membrane, through which monovalent ions (e.g., Cl—) are allowed to pass as permeate. Multivalent ions (e.g., divalent cations such as Ca²⁺ and Mg²⁺) are rejected by the nanofiltration membrane, effectively concentrating the multivalent ions in the retentate. Retentate comprising a concentrated source of multivalent ions may then be recycled for reuse in the processor. Permeate comprising a concentrated source of monovalent ions may be discarded, provided to a desalination plant, or recycled for use with, for example, an electrochemical system of the invention.

In some embodiments, a source of alkalinity (e.g., seawater, brine) comprising multivalent ions (e.g., divalent cations such as Ca²⁺ and/or Mg²⁺) may be provided to a filtration unit (e.g., nanofiltration unit) in which the source of alkalinity may be concentrated to provide a concentrated source of alkalinity and a concentrated source of multivalent cations. In such embodiments, the filtration unit may comprise a membrane, for example, a nanofiltration membrane, through which monovalent ions (e.g., Cl⁻) are allowed to pass as permeate. In such embodiments, multivalent ions (e.g., divalent cations such as Ca²⁺ and/or Mg²⁺) are rejected by the nanofiltration membrane, effectively concentrating the multivalent ions in the retentate. Retentate comprising a concentrated source of multivalent ions may then be provided to the processor. Permeate comprising a concentrated source of monovalent ions may be discarded, provided to a desalination plant, or recycled for use with, for example, an electrochemical system of the invention.

Increasing the concentration of multivalent ions (e.g., divalent cations such as Ca²⁺, Mg²⁺) by filtration of a source of alkalinity or a dewatering system supernatant may increase yields for compositions of the invention, particularly compositions comprising precipitation material (e.g., Ca²⁺, Mg²⁺). Such a concentration of multivalent ions (e.g., divalent cations such as Ca²⁺, Mg²⁺) may make it possible to use smaller tanks, pumps, and/or post-processing equipment. Concomitant with increasing the concentration of multivalent ions in filtration unit retentate (e.g., nanofiltration unit retentate), monovalent ion concentration (e.g., Cl⁻ concentration) may also be reduced. In such embodiments, monovalent ion concentration in compositions (e.g., precipitation material) of the invention may be lessened, reducing the need for washing compositions of the invention; that is, for example, if a low- or no-chloride composition (e.g., precipitation material) is desired. Filtration unit permeate (e.g., nanofiltration unit permeate) resulting from filtration of the source of alkalinity or the dewatering system supernatant may be considered pretreated for desalination, and may be lower scaling, comprising lower total dissolved solids (TDS). Such filtration unit permeate may be provided to desalination plants or desalinated on site.

Compositions from a processor, supernatant from a dewatering system, or permeate from a filtration unit such as a nanofiltration unit may be used in a filtration unit such as a reverse osmosis unit. In some embodiments, the reverse osmosis unit may be configured to provide permeate to an electrochemical system. In some embodiments, the reverse osmosis unit may be configured to provide retentate to an electrochemical system. In some embodiments, a filtration system comprising two filtration units may be used to treat compositions from the processor. In such embodiments, the filtration system may comprise a nanofiltration unit and a reverse osmosis unit, wherein the nanofiltration unit provides permeate to the reverse osmosis unit, and the reverse osmosis unit, in turn, provides retentate to an electrochemical system. A reverse osmosis unit comprises a membrane, for example, a reverse osmosis membrane, through which solvent such as water is allowed to pass as permeate. Multivalent ions and monovalent ions are rejected by the reverse osmosis membrane, effectively concentrating the ions in the retentate. Retentate comprising a concentrated source of ions may then be provided to the electrochemical system. Permeate substantially free of ions may be discarded, provided to a desalination plant, or recycled for any of a number of different uses.

Combinations of the above processes may be used. In some embodiments, a processor composition and a source of alkalinity (e.g., seawater, brines) comprising multivalent ions (e.g., divalent cations such as Ca²⁺ and/or Mg²⁺) may be concentrated by nanofiltration and provided to the processor. In some embodiments, a composition of the processor may be concentrated by a nanofiltration unit, wherein nanofiltration unit retentate may be provided to the processor and permeate may be provided to a reverse osmosis unit for further processing. In some embodiments, the source of alkalinity comprising divalent cations may be concentrated by nanofiltration and processor compositions concentrated by reverse osmosis. In some embodiments, the source of alkalinity comprising divalent cations may be concentrated by nanofiltration and the retentate provided to the processor. In such embodiments, a composition of the processor may be concentrated by nanofiltration, the nanofiltration unit retentate provided back to the processor, and the nanofiltration unit permeate may be concentrated by reverse osmosis and the retentate or permeate provided to an electrochemical system.

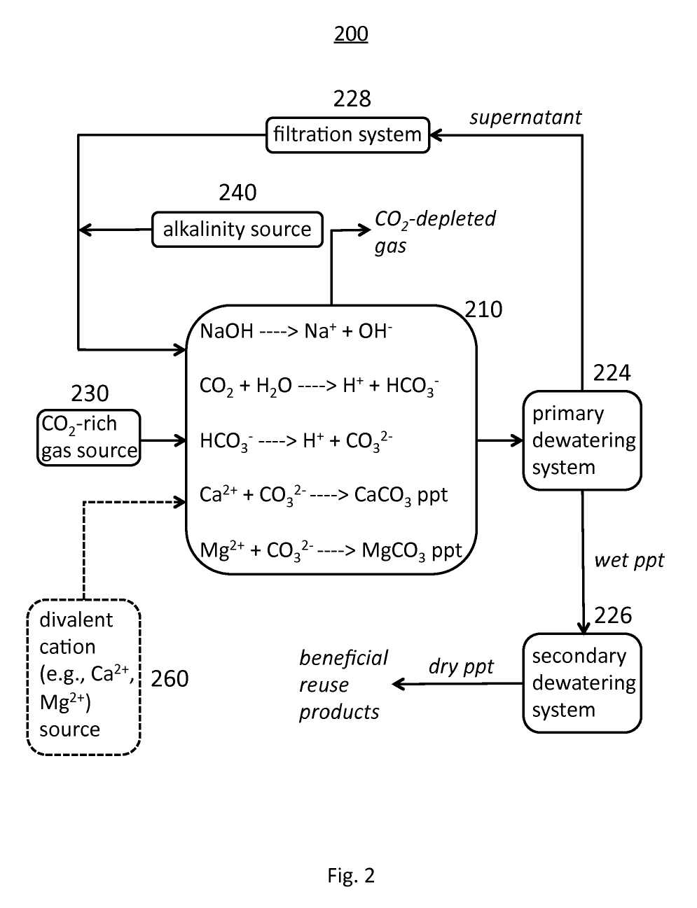

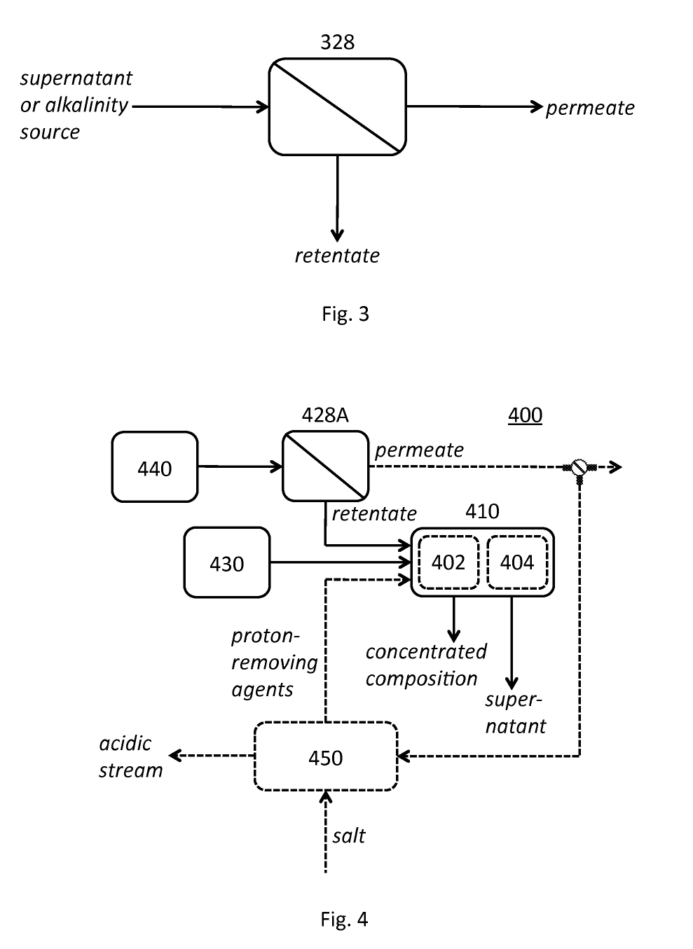

In some embodiments, the invention provides for a method and system for processing carbon dioxide utilizing a recirculating solution. With reference to FIG. 2, in one embodiment, the system 200 comprises a gaseous waste stream rich in carbon dioxide (230). The source of carbon dioxide in contact with the recirculating solution in various embodiments may be any convenient carbon dioxide source as described below.

The nature of the industrial plant may vary in different embodiments and includes industrial plants, power plants, chemical processing plants, and other industrial plants that produce a gaseous stream comprising carbon dioxide as a by-product. The gaseous waste stream (230) may be substantially pure CO₂ or a multi-component gaseous stream that includes CO₂ and one or more additional gases. Additional gases and other components may include SOx (e.g., SO₂), NOx, mercury, and other metals. In some embodiments, one or more of these additional components incorporate into the composition. For example, in some embodiments, one or more of these additional components are precipitated simultaneously or sequentially with precipitation material comprising carbonates, bicarbonates, or carbonates and bicarbonates. For example, SO₂ may be precipitated as calcium sulfate or sulfite.

In some embodiments, the CO₂-containing gas (230) is directed to a processor 210, wherein the CO₂ is brought into contact with the recirculating solution. The processor 210 comprises any of a number of different elements, such as temperature modulation elements (e.g., configured to heat or cool the water to a desired temperature); chemical additive elements (e.g., for introducing chemical pH elevating agents (such as NaOH) into the water); agitation elements; and/or electrochemical components or elements (e.g., cathodes/anodes, etc.). The processor may comprise a single compartment or multiple compartments.

Referring to FIG. 2, in various embodiments, the system includes a source of alkalinity (240) for optionally adjusting the pH of the recirculating solution. Additionally, with reference to FIG. 2, system 200 may include a source of alkaline earth metal ions (260) (e.g., divalent cations such as Ca²⁺ and/or Mg²⁺) suitable for producing a composition comprising carbonates, bicarbonates, or carbonates and bicarbonates from the recirculating solution. Where the source of the alkaline earth metal ions comprises a saltwater source (e.g., seawater, brine, etc.), the input is in fluid communication with the source of saltwater. For example, where the source of saltwater is seawater, the input may be a pipeline or feed from ocean water to a land-based system. In a water-based system, for example, the input may be in a port in the hull of ship. Alternatively, alkaline earth metal ions may be obtained by digesting a mafic mineral or another raw material that is rich in alkaline earth metals (e.g., serpentine or olivine) in accordance with the invention described herein.

As described below, other sources of alkaline earth metals include fly ash, slag, waste concrete, and the like as known in the art. Further sources of alkaline earth metal ions include brines and hard water. In addition, a source of silica such as mafic minerals or fly ash, may be used in some embodiments. In such embodiments, a final solid product comprising silica may be considered a pozzolan.

The system 200 further includes a dewatering system 224 for dewatering the solid portion of a composition comprising carbonates, bicarbonates, or carbonates and bicarbonates (e.g. precipitation material) from the recirculating solution. Depending on the particular dewatering system, the dewatering system may include a filtration unit such as a continuous belt filter, or the dewatering system may comprise a settling tank, or any other conventional dewatering units. The filtered material may be formed into discrete particles, for example, by spray drying or oven drying followed by milling. Spray drying may efficiently use flue gas as a source of heat. In some embodiments, the final solid product may be used in the built environment as a cement or a cement additive such as a supplementary cementitious material (e.g., 20% precipitation material: 80% cement such as ordinary portland cement); fine synthetic aggregate (e.g., sand); coarse synthetic aggregate; gravel; wallboard; a soil remediation product; cement, and the like.

As illustrated in FIG. 2, at primary dewatering system 224, the recirculating solution is obtained by removing precipitation material from the composition comprising the precipitation material and producing supernatant. In various embodiments, the recirculating solution comprises the supernatant formed over the solid portion of the composition comprising carbonates, bicarbonates, or carbonates and bicarbonates (e.g. precipitation material) or the supernatant obtained by subjecting a slurry of precipitation material to liquid-solid separation.

Optionally, in various embodiments, it may be necessary to adjust the pH of the recirculating solution prior to re-contacting it with incoming CO₂-containing gas (230). As will be appreciated in the art, the pH may be adjusted by adding a source of alkalinity (e.g., soluble hydroxide, bicarbonates, etc.) to the recirculating solution. Optionally, the pH may be adjusted by adding a solution wherein the alkalinity (i.e., hydroxide, bicarbonates, etc.) concentration is increased by an electrochemical process as described for example in commonly assigned U.S. Provisional Patent Application No. 61/091,729, which is incorporated herein by reference.

Optionally, it may also be necessary to remove ions from the recirculating solution prior to re-contacting it with incoming CO₂-containing gas 230. As illustrated in FIG. 2, the system in one embodiment includes a filtration unit 228 (e.g., deionizer, nanofiltration unit, reverse osmosis unit, etc.) capable of selectively removing ions from the recirculating solution. For example, a system capable of removing all or most of the divalent cations (e.g., Mg² and Ca²⁺) to one compartment, and remove monovalent ions e.g., Na⁺ and Cl⁻ to another compartment, may be used. Useful systems include nanofiltration units. In some embodiments, divalent cation-rich water is reintroduced into processor 210, while monovalent ion-rich water is used, for example, in an electrochemical process for removing protons and/or producing hydroxide, bicarbonates, carbonates, or a mixture thereof. In addition, a system of the invention may be used to produce silica-rich water from a feed containing silica.

The system may be located on land or on water (e.g., the oceans). For example, the system may be a land-based system in a coastal region (i.e., close to a source of seawater), or in an interior location where water is piped into the system from a saltwater source (e.g., ocean, inland water, subterranean brine, etc.). Alternatively, the system may be a water-based system (i.e., a system that is present on or in water). Such a system may be present on a boat, ocean-based platform etc., as desired.

Methods and systems of the invention are adaptable for batch and continuous processes as described herein and as one ordinarily skilled in the art will appreciate.

In some embodiments, the method comprises a step whereby CO₂-containing gas is contacted with the recirculating solution. As is described above, in this step, CO₂ from the CO₂-containing gas 230 may be contacted with the recirculating solution in processor 210. Optionally, the pH of the recirculating solution is sufficiently adjusted to promote the absorption of the gas in the liquid.

In some embodiments, the method further comprises producing a composition comprising carbonates, bicarbonates, or carbonates and bicarbonates of alkaline earth metals. In some embodiments, such compositions may be precipitated as a precipitation material from the recirculating solution.

As indicated in FIG. 2, various reactions occur in the processor (210) to cause the precipitation. In particular, as will be appreciated by one skilled in the art, and without being bound by theory, the following reactions may occur in the processor to produce precipitation material comprising carbonates:

NaOH---->Na⁺+OH⁻

CO₂+H₂O---->H⁺+HCO₃⁻

HCO₃⁻---->H⁺CO₃²⁻

Ca²⁺+CO₃²⁻---->CaCO₃(s)

Mg²⁺+CO₃²⁻---->MgCO₃(s)

Calcium carbonate and magnesium carbonate, or combinations thereof, may exist in any of a number of polymorphic states, as well as with or without one or more waters of hydration, depending on conditions under which precipitation was produced. In some embodiments, flocculation and/or seeding are used to optimize precipitation or influence a particular polymorph over another.

In some embodiments, the method further comprises recovering and dewatering precipitation material in a dewatering system 224 by any means to separate and recover the precipitation material and supernatant. This step may include decantation or subjecting the wet precipitation material to liquid-solid separation to recover supernatant.

In some embodiments, the method further comprises recovering supernatant and recycling the supernatant as the recirculating solution. Optionally, precipitation material may be recovered, dried, and further processed to make useful products (e.g., beneficial reuse products). In an alternative embodiment, at least a portion of the recirculating solution may be diluted and pumped to an ocean depth or reservoir depth at which the temperature and pressure are sufficient to keep the carbon dioxide in solution without precipitating the carbonates. In another embodiment, precipitation material comprising carbonates, bicarbonates, or carbonates and bicarbonates are disposed of without further processing. For example, the precipitation material may be simply stored on land or in the ocean. In some embodiments, a composition comprising carbonates, bicarbonates, or carbonates and bicarbonates is pumped into a subterranean as described in U.S. Provisional Patent Application No. 61/232,401, filed 7 Aug. 2009, which is incorporated herein by reference in its entirety. It will be appreciated that the parasitic load, carbon footprint, amount of energy used, and/or amount of CO₂ produced for processing a given amount of CO₂ from a CO₂-containing gas is minimized in a process where no further processing of the composition occurs beyond disposal. In various embodiments, depending on how the alkaline earth metals ions are introduced to the system 200, a portion of the recirculating solution may be purged to maintain a batch or steady state flow as will be appreciated in the art.

Embodiments described above produce electrolyte solutions enriched in bicarbonate ions, carbonate ions, hydroxide ions, or combinations thereof, as well as an acidified stream in embodiments wherein the source of hydroxide ions is an electrochemical process. An electrochemical process may be one in which a voltage is applied across one or more ion-selective membranes and the solutions on different sides of the membrane achieve a pH difference of pH 1-14, for example, a pH of pH 0-14, a pH of pH 4-12; or a pH of pH 4-13, and any other suitable range. In some embodiments, the electrochemical process is one in which the voltage applied across the anode and the cathode of the electrochemical cell is less than 2.8 volts and no chlorine or oxygen gas is evolved at the anode. In some embodiments, the electrochemical process is one in which the voltage applied across the anode and the cathode of the electrochemical cell is less than 2.8 volts and no gas is evolved at the anode.

The acidified stream may also find application in various chemical processes. For example, the acidified stream may be employed to dissolve calcium and/or magnesium rich minerals such as serpentine and olivine to create a source of divalent cations for the processor 210. Such minerals may be pretreated before acid treatment or simultaneously with acid treatment to increase surface area (e.g., by jet milling, ball milling, sonification, or any other suitable process to destroy crystal structure) and/or to increase reaction rates. Such a source of divalent cations may be charged with bicarbonate ions and then made sufficiently basic so as to precipitate carbonates. Such precipitation reactions and the use of the resultant precipitation material in cements are further described in U.S. patent application Ser. No. 12/126,776, titled “Hydraulic cements comprising carbonate compound compositions,” filed on 23 May 2008, which is incorporated herein by reference.

In some embodiments, rather than precipitating carbonate-based minerals to process CO₂, the bicarbonate-enriched solution may be disposed of in a location where it will be stable for extended periods of time. For example, the bicarbonate-enriched solution may be pumped to an ocean depth where the temperature and pressure are sufficient to keep the solution stable.

As reviewed above, carbon dioxide-processing systems of the invention may comprise a filtration system comprising a filtration unit or combination of filtration units selected from the group consisting of an ultrafiltration unit, a nanofiltration unit, and a reverse osmosis unit.

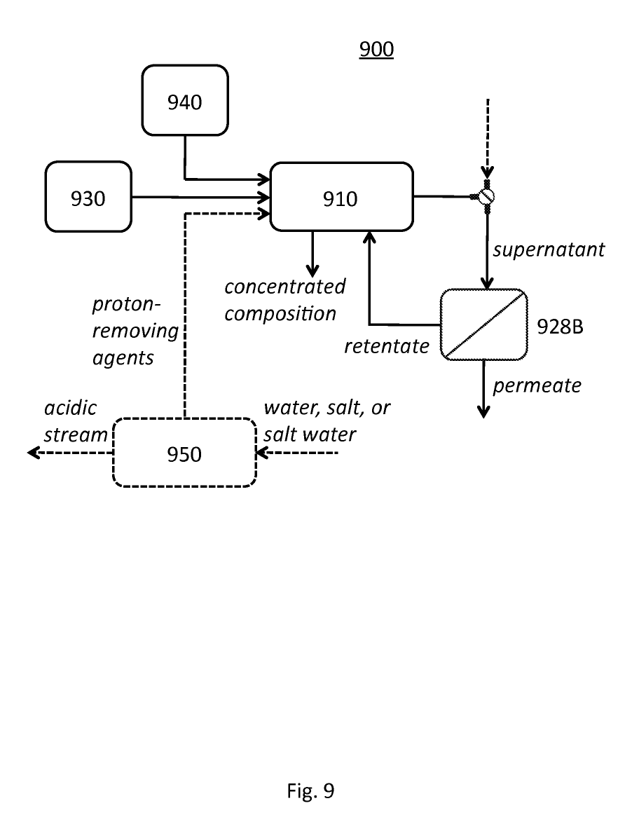

A carbon dioxide-processing system may be configured, in some embodiments with a filtration unit for concentrating a source of alkalinity prior to providing the source of alkalinity to a carbon dioxide processor of the system. As such, a source of alkalinity from naturally occurring sources (e.g., saltwater, freshwater, brine, etc.) or anthropogenic sources (e.g., desalination wastewater) may be treated by a filtration unit (e.g., a nanofiltration unit, a reverse osmosis unit, etc.) to provide a more concentrated source of alkalinity. Retentate from the filtration unit (e.g., nanofiltration unit) may be provided directly to the processor (e.g., gas-liquid contactor, gas-liquid-solid contactor, reactor, etc.) for preparation of compositions of the invention, including precipitation material (e.g., CaCO₃, MgCO₃, or combinations thereof). In some embodiments, a source of alkalinity from a naturally occurring source is concentrated with respect to divalent cations by a combination of filtration and addition of supplementary divalent cations. In such embodiments, retentate from the filtration unit (e.g., nanofiltration unit) may be treated with additional salts and/or minerals prior to providing the retentate to the processor. With this in mind, a source of alkalinity comprising cations such as Ca²⁺ and Mg²⁺ may be operably connected to a filtration unit (e.g., an ultrafiltration unit, a nanofiltration unit, a reverse osmosis unit) configured to provide retentate (a concentrated source of alkalinity) to a carbon dioxide-processing system processor as illustrated in FIGS. 4, 5, 6, 7, and 8. Such systems may be advantageous when the source of alkalinity is, for example, seawater or freshwater. In some embodiments, a source of alkalinity is sufficiently concentrated for use in a carbon dioxide-processing system processor. In such embodiments, the source of alkalinity need not be concentrated as exemplified by the carbon dioxide-processing systems of FIGS. 9, 10, and 11. Such sources of alkalinity that need not be concentrated include variously available brines.

FIG. 4 provides a system according to one embodiment of the invention. In such embodiments, carbon dioxide-processing system 400 comprises a source of alkalinity (440) comprising, for example, Ca²⁺ and/or Mg²⁺, which is operably connected to filtration unit 428A (e.g., nanofiltration unit) by means of conduit or an equivalent structure. Filtration unit 428A comprises a membrane (e.g., a nanofiltration membrane) adapted to allow a solution of monovalent ions such as Na⁺ and Cl⁻ to pass through as permeate while a solution of multivalent ions such as Ca²⁺ and Mg²⁺ are rejected by the membrane as retentate. As such, the filtration unit may be configured to provide retentate as a concentrated source of alkalinity, wherein the retentate is concentrated with respect to multivalent ions such as Ca²⁺ and Mg²⁺. As shown, filtration unit 428A is operably connected to processor 410 by means of a retentate conduit or an equivalent structure configured to transport retentate from the filtration unit to the processor where the concentrated source of alkalinity may be processed with a gaseous waste stream comprising carbon dioxide (i.e., a source of CO₂-containing gas). To this end, the processor, which may further comprise a gas-liquid or gas-liquid-solid contactor (402), a reactor (404), a settling tank (406) (not shown), or a combination thereof, is operably connected to the source of CO₂-containing gas (430) by means of a conduit or an equivalent structure. With this in mind, the carbon dioxide-processing system may be configured such that the gaseous waste stream is provided to a gas-liquid or gas-liquid-solid contactor as shown, for example, in FIG. 5. With or without addition of proton-removing agents from an optional electrochemical system (450), a gas-liquid or gas-liquid solid contactor of the processor may be configured to produce a composition comprising carbonates, bicarbonates, or carbonates and provide the composition to a reactor, to a settling tank, or to a combination thereof for further processing. Any of the foregoing processor sub-systems, or combinations thereof, may be operably connected to a dewatering system (not shown) for dewatering compositions of the invention, wherein dewatering comprises producing a supernatant and a composition concentrated with respect to carbonates, bicarbonate, or carbonates and bicarbonates. While the dewatering system is not generally considered part of the processor as discussed herein, the dewatering system may be considered part of the processor for the express purpose of describing the configurations of FIGS. 4-11. As described herein, the dewatering system along with the filtration system is generally considered a treatment system of the invention. Regarding the optional electrochemical system, the carbon dioxide-processing system of the invention may be configured to provide permeate to the electrochemical system from filtration unit 428A, which permeate may optionally be further purified in one or additional filtration units prior to being provided to the electrochemical system. The carbon dioxide-processing system may also be configured to provide salt or make-up salt to the electrochemical system, if present. For example, the system of the invention may be configured to provide solid or aqueous sodium chloride to the electrochemical system. As above, the optional electrochemical system may be configured to provide proton-removing agents (e.g., NaOH) to the gas-liquid or gas-liquid-solid contactor of the processor. (See, for example, U.S. patent application Ser. No. 12/541,055, filed 13 Aug. 2009, and U.S. patent application Ser. No. 12/617,005, filed 12 Nov. 2009, each of which is incorporated herein by reference in its entirety.) The electrochemical system may be further configured to provide proton-removing agents to any processor sub-system including, but not limited to, the reactor or combinations of processor sub-systems. As such, the electrochemical system, if present, may provide proton-removing agents to the processor. As shown, the electrochemical system, if present, may also be configured to eliminate an acidic stream (e.g., HCl), which may be used by the carbon dioxide-processing system to digest industrial waste or rocks and minerals as shown in FIG. 5.

FIG. 5 provides a system according to one embodiment of the invention. As with FIG. 4, carbon dioxide-processing system 500 comprises a source of alkalinity (540) comprising, for example, seawater comprising Ca²⁺ and/or Mg²⁺, which is operably connected to filtration unit 528A (e.g., nanofiltration unit) by means of conduit or an equivalent structure. Filtration unit 528A comprises a membrane (e.g., a nanofiltration membrane) adapted to allow a solution of monovalent ions such as Na⁺ and Cl⁻ to pass through as permeate while a solution of multivalent ions such as Ca²⁺ and Mg²⁺ are rejected by the membrane as retentate. As such, the filtration unit may be configured to provide retentate as a concentrated source of alkalinity, wherein the retentate is concentrated with respect to multivalent ions such as Ca²⁺ and Mg²⁺ and depleted in monovalent ions such as Na⁻ and Cl⁻. As shown, filtration unit 528A is operably connected to reactor (504) by means of a retentate conduit or an equivalent structure configured to transport retentate (a concentrated source of alkalinity) from the filtration unit to the reactor where the concentrated source of alkalinity may be processed together with a CO₂-charged solution, which CO₂-charged solution may comprise carbonates, bicarbonates, or carbonates and bicarbonates (e.g., NaHCO₃), to produce a composition of the invention comprising carbonates, bicarbonates, or carbonates and bicarbonates (e.g., CaCO₃, MgCO₃, or combination thereof, including MgCa(CO₃)₂). The carbon dioxide-processing system of FIG. 5 may further comprise a contactor (502) such as a gas-liquid contactor or gas-liquid-solid contactor configured to produce the CO₂-charged solution, wherein the contactor is operably connected to a source of CO₂-containing gas (530) (e.g., power plant such as a coal-fired power plant) and an electrochemical system (550) configured to provide a source of proton-removing agents (e.g., aqueous sodium hydroxide). As shown, the contactor may also be operably connected to the reactor such that the CO₂-charged solution may be directly provided to the reactor. The combination of the contactor and the reactor, as described herein, comprises a carbon dioxide processor of the invention. Though not shown, the processor may further comprise a settling tank, which may be configured to produce supernatant and a composition concentrated with respect to carbonates, bicarbonate, or carbonates and bicarbonates (e.g., CaCO₃, MgCO₃, or combination thereof, including MgCa(CO₃)₂). The reactor, as shown, may also be configured to act as the settling tank in some modes of operation. As such, the reactor may be configured to produce the supernatant and the concentrated composition. Regarding the electrochemical system (550), the carbon dioxide-processing system of the invention may be configured to provide permeate to the electrochemical system from filtration unit 528A, which permeate may optionally be further purified in one or additional filtration units prior to being provided to the electrochemical system. The carbon dioxide-processing system may also be configured to provide salt or make-up salt to the electrochemical system. For example, the system may be configured to provide solid or aqueous sodium chloride to the electrochemical system. As above, the electrochemical system may be configured to provide proton-removing agents (e.g., NaOH) to the gas-liquid or gas-liquid-solid contactor of the processor for producing the CO₂-charged solution. As shown, the electrochemical system may also be configured to eliminate an acidic stream (e.g., HCl), which may be used by the carbon dioxide-processing system to digest industrial waste or rocks and minerals in a raw material processor (570). In some embodiments, for example, the raw material processor is configured to digest magnesium silicates (e.g., MgSiO₃) (e.g., serpentine, olivine, etc.) with HCl (aq) to produce rock salt (e.g., MgCl₂) and sand (SiO₂), which may be used together or separately to melt ice on roads. (See U.S. patent application Ser. No. 12/501,217, filed 10 Jul. 2009, which is incorporated herein by reference in its entirety, for additional systems and methods for digesting minerals such as magnesium silicates.) In some embodiments, the raw material processor is configured to digest magnesium silicates with HCl (aq) to produce divalent cations (e.g., Mg²⁺) for use in processor 550.

In some embodiments, the invention provides methods of producing compositions comprising carbonates, bicarbonates, or a combination thereof utilizing systems such as those provided in FIGS. 4 and 5. In some embodiments, for example, a source of alkalinity (e.g., seawater, brine, etc.) comprising divalent cations such as Ca²⁺ and Mg²⁺ may be passed through a filtration unit (e.g., filtration unit 528A, such as a nanofiltration unit) to separate the source of alkalinity into a permeate comprising monovalent ions (e.g., Na⁻, Cl⁻) and a retentate comprising multivalent ions (e.g., divalent cations such as Ca²⁺ and/or Mg²⁺). Permeate comprising monovalent ions may be subsequently processed by the electrochemical system (e.g., electrochemical system 550) to produce an aqueous solution comprising a proton-removing agent (e.g., NaOH (aq)) and another aqueous solution comprising an acid (e.g., HCl (aq)). The aqueous solution comprising the acid may be provided to any of a number of acid-utilizing processes, including, but not limited to, raw material processing in a raw material processing unit (570) configured to digest magnesium silicates (e.g., serpentine, olivine, etc.) with HCl (aq) and to produce divalent cations (e.g., Mg²⁺) for subsequent use in the process or for use as rock salt (e.g., MgCl₂) and sand (SiO₂), which may be used together or separately to melt ice on roads. With a gas-liquid contactor or gas-liquid-solid contactor of the invention (e.g., 502), the solution comprising the proton-removing agent (e.g., NaOH (aq)) may be combined with carbon dioxide from an industrial source to produce a solution comprising bicarbonates (e.g., NaHCO₃). The bicarbonate-containing solution may then be combined with retentate comprising divalent cations such as Ca²⁺ and Mg²⁺ to produce a stream comprising unused proton-removing agents (e.g., NaOH(aq)) and a composition comprising carbonates, bicarbonates, or carbonates and bicarbonates. In some embodiments, the composition comprises precipitation material comprising carbonates, bicarbonates, or carbonates and bicarbonates of alkaline earth metals. In some embodiments, the precipitation material may be processed to produce a beneficial reuse product such as a cement, an aggregate, a supplementary cementitious material, or the like.

A carbon dioxide-processing system may also be configured, in some embodiments, with a filtration unit configured to produce a concentrated processor composition comprising carbonates, bicarbonates, or carbonates and bicarbonates of alkali and/or alkaline earth metals. In some embodiments, the carbon dioxide-processing system may be further configured to provide (i.e., recirculate) the concentrated processor composition, which may be more concentrated with respect to, for example, hydrated carbon dioxide species (e.g., carbonic acid, bicarbonates, carbonates) and/or multivalent ions (e.g., Ca²⁺, Mg²⁺, or combinations thereof), back to the processor. In such embodiments, retentate from the filtration unit (e.g., nanofiltration unit) may be provided directly to the processor (e.g., gas-liquid contactor, gas-liquid-solid contactor, reactor, etc.) for preparation of compositions of the invention, including precipitation material (e.g., CaCO₃, MgCO₃, or combinations thereof). Due to efficient use of resources, a carbon dioxide-processing system in accordance with these embodiments may have a lower parasitic load on a power-providing plant.

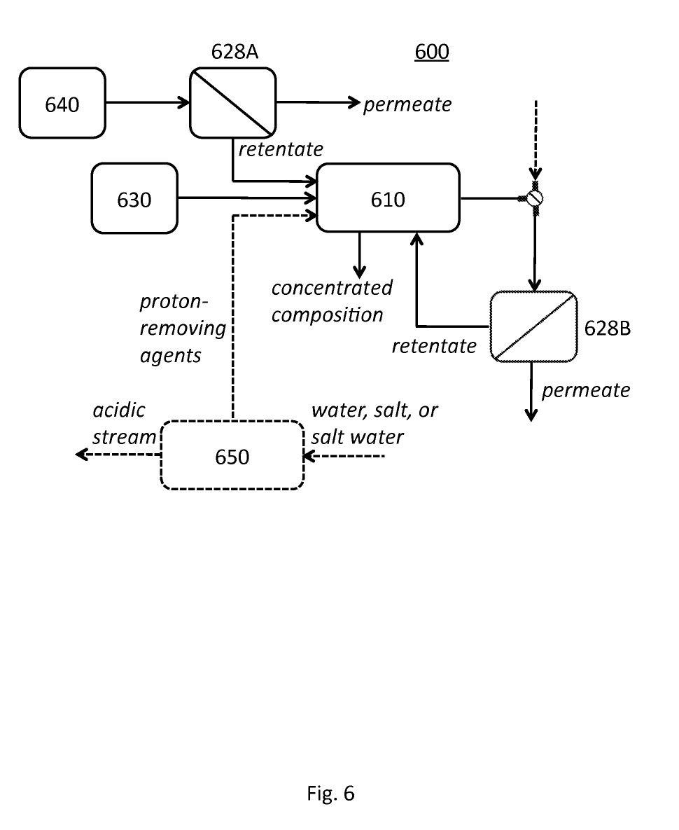

As such, the processor may be operably connected to a filtration unit (e.g., an ultrafiltration unit, a nanofiltration unit, a reverse osmosis unit) configured to recirculate retentate (i.e., processor effluent concentrated with respect to multivalent ions such as Ca²⁺ and Mg²⁺) to the processor as illustrated in FIGS. 6, 8, 9, and 11. Permeate from the filtration unit may be reused without further processing in another part of the system, reused with further processing in another part of the system, or simply discarded.

With respect to FIG. 6, for example, a carbon dioxide-processing system of the invention may comprise a filtration unit (e.g., a nanofiltration unit) configured to filter a processor effluent (e.g. a composition comprising carbonates, bicarbonates, or carbonates and bicarbonates of alkali and/or alkaline earth metals) and provide the processor effluent to the processor in concentrated form as illustrated in FIGS. 6, 8, 9, and 11. In such embodiments, a conduit connected to both the filtration unit and the processor provides a processor effluent (e.g., a composition comprising carbonates, bicarbonates, or carbonates and bicarbonates) to the filtration unit. With reference to FIG. 9, processor effluent is provided by processor 910 (e.g., gas-liquid contactor, gas-liquid-solid contactor, reactor, etc.) to filtration unit 928B by means of a processor effluent conduit. Filtration unit 928B, by means of, for example, a nanofiltration membrane, is adapted to allow monovalent ions (e.g., sodium) to pass though the nanofiltration membrane as permeate while multivalent ions (e.g., Ca²⁺, Mg²⁺) are rejected as retentate. Permeate comprising monovalent ions may be discarded or recycled for use with, for example, electrochemical system 950. Retentate comprising multivalent ions is provided to the processor (910) by means of a conduit connecting the filtration unit (928B) to the processor (910).

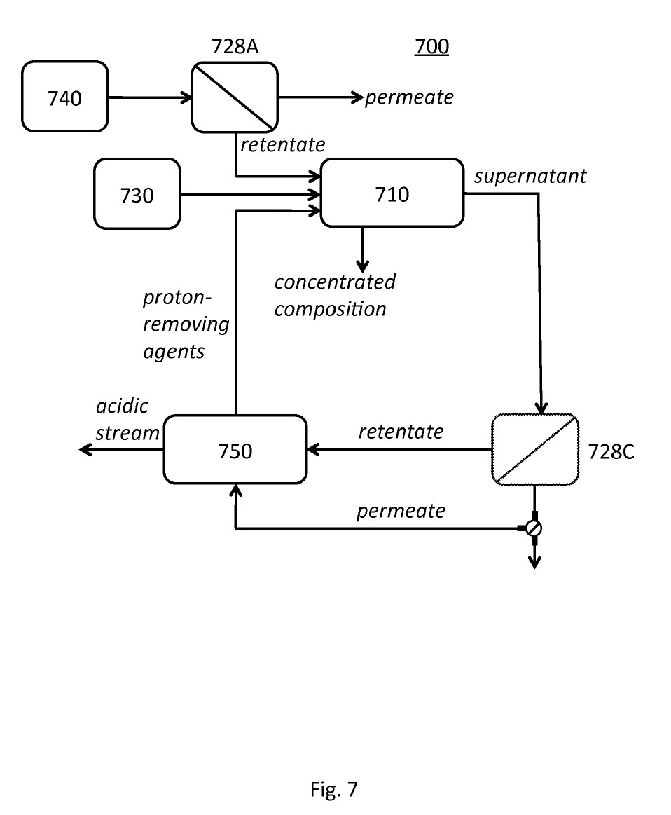

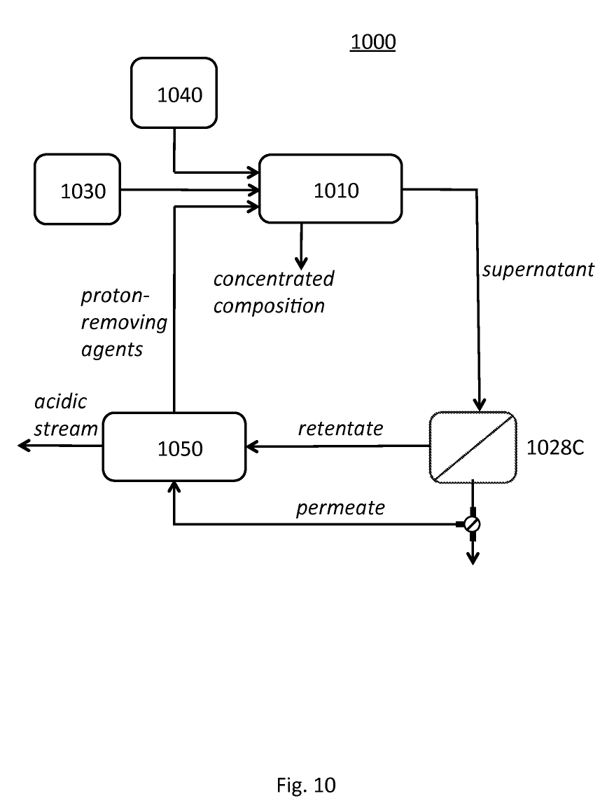

In some embodiments, the filtration unit may be a reverse osmosis-type of filtration unit as illustrated in FIGS. 7, 8, 10, and 11. With reference to FIG. 10, carbon dioxide-processing system 1000 comprises filtration unit 1028C and electrochemical system 1050, each of which is operably connected to processor 1010. Filtration unit 1028C, as shown, is operably connected to the processor (1010) by means of a processor effluent conduit. Filtration unit 1028C comprises a membrane, for example, a reverse osmosis membrane, adapted to allow water to pass through the reverse osmosis membrane as permeate while monovalent and multivalent ions are rejected by the reverse osmosis membrane as retentate. By means of a retentate conduit, filtration unit retentate is provided to electrochemical system 1050. Filtration unit permeate may be discarded, or used in any of a number of different uses (e.g., further purified for drinking water).

Combinations of the systems described for FIGS. 4, 9, and 10 are also possible. In some embodiments, systems comprise two filtration units, for example, two nanofiltration units or one nanofiltration unit and one reverse osmosis unit. FIG. 6 illustrates one embodiment in which two filtration units are featured. As shown, carbon dioxide-processing system 600 comprises filtration unit 628A and filtration unit 628B, each of which is operably connected to processor 610. The carbon dioxide-processing system further comprises an electrochemical system (650) operably connected as illustrated in FIG. 6. Filtration unit 628A, as shown, is operably connected to the processor (610) by means of retentate conduit. In addition, a source of alkalinity comprising, for example, Ca²⁺ and Mg²⁺, is provided to the filtration unit (628A) by means of a conduit as shown. Filtration unit 628A comprises a membrane, for example, a nanofiltration membrane, adapted to allow monovalent ions such as Na⁺ to pass through the nanofiltration membrane as permeate while multivalent ions such as Ca²⁺ and Mg²⁺ are rejected by the nanofiltration membrane as retentate. By means of retentate conduit, filtration unit retentate is provided to processor 610 (e.g., gas-liquid contactor, gas-liquid-solid contactor, reactor, etc.), where a composition from, for example, divalent cations and an industrial source of carbon dioxide may be produced. A processor effluent (e.g., a composition comprising carbonates, bicarbonates, or carbonates and bicarbonates of alkali and/or alkaline earth metals) is provided by processor 610 to filtration unit 628B by means of a processor effluent conduit. Filtration unit 628B, by means of, for example, a nanofiltration membrane, is adapted to allow monovalent ions (e.g., Na⁺, Cl⁻) to pass though the nanofiltration membrane as permeate while multivalent ions (e.g., Ca²⁺, Mg²⁺) are rejected as retentate. Permeate comprising monovalent ions may be discarded or recycled for use with, for example, electrochemical system 650. Retentate comprising multivalent ions is provided to the processor (610) by means of a conduit connecting the filtration unit (628B) to the processor (610).

FIG. 7 illustrates another embodiment in which two filtration units are featured. As shown, carbon dioxide-processing system 700 comprises filtration unit 728A, filtration unit 728C, and electrochemical system 750, each of which is operably connected to processor 710. Filtration unit 728A, as shown, is operably connected to the processor (710) by means of a retentate conduit. In addition, a source of alkalinity comprising, for example, Ca²⁺ and Mg²⁺, is provided to the filtration unit (728A) by means of a conduit as shown. Filtration unit 728A comprises a membrane, for example, a nanofiltration membrane, adapted to allow monovalent ions such as Na⁺ and Cl⁻ to pass through the nanofiltration membrane as permeate while multivalent ions such as Ca²⁺ and Mg²⁺ are rejected by the nanofiltration membrane as retentate. By means of retentate conduit, filtration unit retentate is provided to processor 710 (e.g., gas-liquid contactor, gas-liquid-solid contactor, reactor, etc.), where a composition from, for example, divalent cations and an industrial source of carbon dioxide may be produced. Filtration unit 728C, as shown, is operably connected to the processor (710) by means of a processor effluent conduit. Filtration unit 728C comprises a membrane, for example, a reverse osmosis membrane, adapted to allow water to pass through the reverse osmosis membrane as permeate while monovalent and multivalent ions are rejected by the reverse osmosis membrane as retentate. By means of retentate conduit, filtration unit retentate is provided to the electrochemical system (710). Filtration unit permeate may be discarded, or recycled or used in any of a number of different uses (e.g., further purified for drinking water).

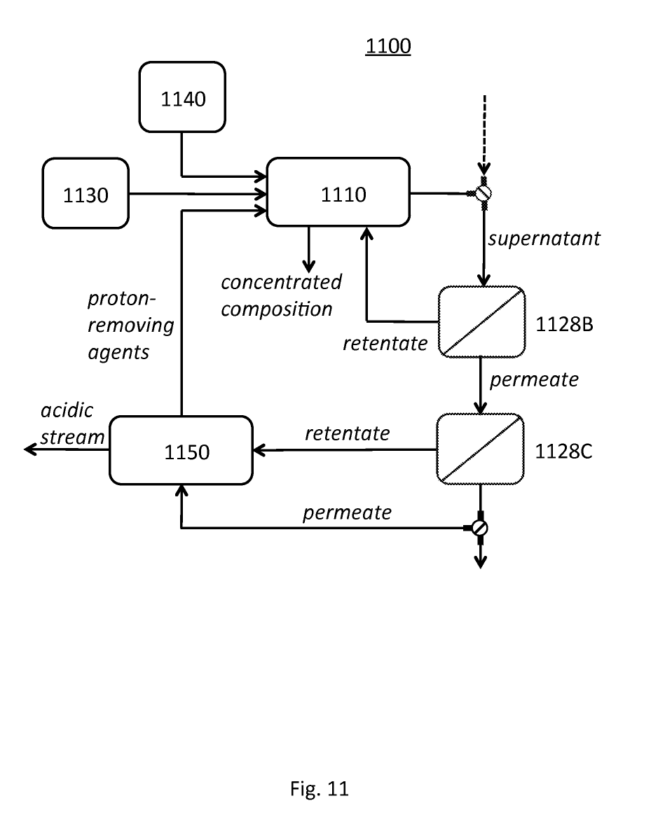

FIG. 11 illustrates yet another embodiment in which two filtration units are featured. As shown, carbon dioxide-processing system 1100 comprises filtration unit 1128B and processor 1110, each of which is operably connected to filtration unit 1128C. The carbon dioxide-processing system further comprises an electrochemical system (1150) operably connected as illustrated in FIG. 11. As illustrated, filtration unit 1128B (e.g., a nanofiltration unit) is configured to recycle processor effluent and provide the processor effluent to processor 1110 in concentrated form. A conduit connected to both filtration unit 1128B and the processor (1110) provides a processor effluent (e.g., a composition comprising carbonates, bicarbonates, or carbonates and bicarbonates of alkali and/or alkaline earth metals) to the filtration unit. Processor effluent is provided by processor 1110 to filtration unit 1128B by means of a processor effluent conduit. Filtration unit 1128B, by means of, for example, a nanofiltration membrane, is adapted to allow monovalent ions (e.g., Na⁺, Cl⁻) to pass though the nanofiltration membrane as permeate while multivalent ions (e.g., Ca²⁺, Mg²⁺) are rejected as retentate. Retentate comprising multivalent ions is provided to the processor (1110) by means of a conduit connecting the filtration unit (1128B) to the processor (1110). Permeate comprising monovalent ions is provided to the filtration unit (1128C) by means of a conduit connecting filtration unit 1128B to filtration unit 1128C. Filtration unit 1128C comprises a membrane, for example, a reverse osmosis membrane, adapted to allow water to pass through the reverse osmosis membrane as permeate while monovalent and multivalent ions are rejected by the reverse osmosis membrane as retentate. By means of a retentate conduit, filtration unit retentate is provided to the electrochemical system (1150). Filtration unit permeate may be discarded, or recycled or used in any of a number of different uses (e.g., further purified for drinking water).

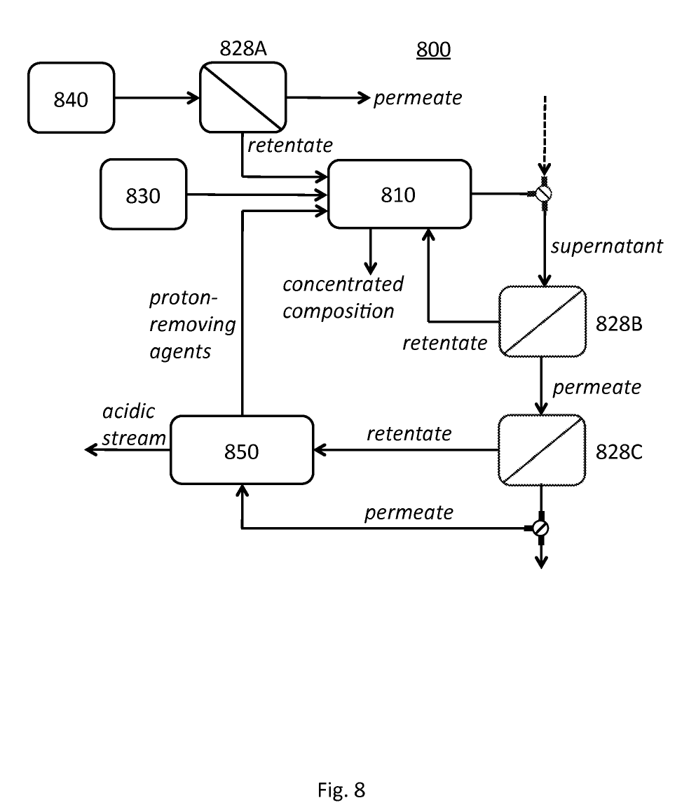

FIG. 8 illustrates yet another embodiment in which combinations of filtration units are featured. Carbon dioxide-processing system 800 comprises filtration unit 828A, filtration unit 828B, filtration unit 828C, processor 810, and electrochemical system 850 operably connected as illustrated in FIG. 8. Filtration unit 828A, as shown, is operably connected to the processor (810) by means of a retentate conduit. In addition, a source of alkalinity comprising, for example, Ca²⁺ and Mg²⁺, may be provided to the filtration unit (828A) by means of a conduit as shown. Filtration unit 828A comprises a membrane, for example, a nanofiltration membrane, adapted to allow monovalent ions such as Na⁺ and Cl⁻ to pass through the nanofiltration membrane as permeate while multivalent ions such as Ca²⁺ and Mg²⁺ are rejected by the nanofiltration membrane as retentate. By means of retentate conduit, filtration unit retentate is provided to processor 810 (e.g., gas-liquid contactor, gas-liquid-solid contactor, reactor, etc.), where a composition from, for example, divalent cations and an industrial source of carbon dioxide may be produced. Filtration unit 828B (e.g., a nanofiltration unit) is configured to recycle processor effluent and provide the processor effluent to processor 810 in concentrated form. A conduit connected to both filtration unit 828B and the processor (810) provides a processor effluent (e.g., a composition comprising carbonates, bicarbonates, or carbonates and bicarbonates of alkali and/or alkaline earth metals) to filtration unit. Processor effluent is provided by processor 810 to filtration unit 828B by means of a processor effluent conduit. Filtration unit 828B, by means of, for example, a nanofiltration membrane, is adapted to allow monovalent ions (e.g., Na⁺, Cl⁻) to pass though the nanofiltration membrane as permeate while multivalent ions (e.g., Ca²⁺, Mg²⁺) are rejected as retentate. Retentate comprising multivalent ions is provided to the processor (810) by means of a conduit connecting the filtration unit (828B) to the processor (810). Permeate comprising monovalent ions is provided to the filtration unit (828C) by means of a conduit connecting filtration unit 828B to filtration unit 828C. Filtration unit 828C comprises a membrane, for example, a reverse osmosis membrane, adapted to allow water to pass through the reverse osmosis membrane as permeate while monovalent and multivalent ions are rejected by the reverse osmosis membrane as retentate. Reverse osmosis membranes useful in some embodiments include Dow (e.g., FilmTec membranes: FilmTec NF200-400, FilmTec NF270-400), GE (e.g., SeaSoft™ Series: Seasoft 8040 HR, Seasoft 8040 HF), Koch (e.g. SW-400), and R.O. Ultra Tec (e.g., NF3 Series). In some embodiments, a filtration unit comprising a nanofiltration or reverse osmosis membrane rejects more than 75%, more than 85%, more than 90%, more than 91%, more than 92%, more than 93%, more than 94%, more than 95%, more than 96%, more than 97%, more than 98%, more than 99%, more than 99.5% of incident multivalent ions. In some embodiments, a filtration unit comprising a reverse osmosis membrane rejects more than 75%, more than 85%, more than 90%, more than 91%, more than 92%, more than 93%, more than 94%, more than 95%, more than 96%, more than 97%, more than 98%, more than 99%, more than 99.5% of incident monovalent ions. In some embodiments, nanofiltration or reverse osmosis provides a multivalent ion concentration factor of at least 1.5, at least 2, at least 3, at least 4, at least 5, at least 6, at least 7, at least 8, at least 9, at least 10. In some embodiments, reverse osmosis provides a monovalent ion concentration factor at least 1.5, of at least 2, at least 3, at least 4, at least 5, at least 6, at least 7, at least 8, at least 9, at least 10. High multivalent ion rejection by a filtration unit (e.g., nanofiltration or reverse osmosis unit) may increase yields of compositions comprising carbonates, bicarbonates, or carbonates and bicarbonates, including precipitation material; high monovalent ion rejection may increase long-term stability of structures (e.g., reinforced roadways) produced using products of the invention (e.g., precipitation material comprising carbonates, bicarbonates, or carbonates and bicarbonates of alkaline earth metals.).

In some embodiments, the invention provides methods of producing compositions comprising carbonates, bicarbonates, or a combination thereof utilizing systems such as that provided in FIG. 8. In some embodiments, for example, source of alkalinity 840 (e.g., freshwater, seawater, brine, etc.) comprising divalent cations such as Ca²⁺ and/or Mg²⁺ may be passed through filtration unit 828A (e.g., nanofiltration unit, reverse osmosis unit, etc.) to separate the source of alkalinity into a permeate and a retentate. (This method of concentrating the source of alkalinity (e.g., freshwater, seawater) may also be practiced with systems such as the systems of FIGS. 4-8; however, methods of the invention also provide for using the source of alkalinity (e.g., brine) without concentrating as shown in FIGS. 9-11.) In some embodiments, for example, a nanofiltration unit is used to separate the source of alkalinity into a permeate comprising monovalent ions (e.g., Na⁺, Cl⁻) and a retentate comprising multivalent ions (e.g., divalent cations such as Ca²⁺ and/or Mg²⁺). Permeate comprising monovalent ions may be subsequently processed by an electrochemical system (as shown in, for example, FIGS. 4 and 5) or desalinated. Retentate comprising increased alkalinity and/or hardness (e.g., Ca²⁺ and/or Mg²⁺) may then be provided to processor 810, or a sub-system (e.g., gas-liquid contactor, gas-liquid-solid contactor, reactor, etc.) thereof, and processed with an industrial source of carbon dioxide to form a composition of the invention. In some embodiments, the retentate (or source of alkalinity, if not concentrated) may be combined in a gas-liquid contactor or gas-liquid-solid contactor of the processor. As shown in FIG. 8 (as well as FIGS. 4-7 and 9-11), proton-removing agents may also be added to the processor or processor sub-system for processing CO₂. In some embodiments, for example, it maybe desirable to increase the pH of a composition comprising carbonates, bicarbonates, or carbonates and bicarbonates using proton-removing agents to facilitate formation of precipitation material. By means of a settling tank or an alternative dewatering system described herein, a concentrated composition (i.e., concentrated with respect to carbonates, bicarbonates, or carbonates and bicarbonates) may be produced. In some embodiments, the concentrated composition is further processed to produce beneficial reuse products (e.g., cement, an aggregate, a supplementary cementitious material, or the like). In some embodiments, the concentrated composition is simply disposed. Supernatant resulting from production of the concentrated composition may, as shown in FIG. 8, be passed through filtration unit 828B (e.g., nanofiltration unit, reverse osmosis unit, etc.) to separate the supernatant into a permeate and a retentate. In some embodiments, for example, a nanofiltration unit is used to separate the supernatant into a permeate comprising monovalent ions (e.g., Na⁺, Cl⁻) and a retentate comprising multivalent ions (e.g., divalent cations such as Ca²⁺ and/or Mg²⁺). (This method of concentrating the supernatant with a nanofiltration unit may also be practiced with systems such as the systems of FIGS. 6, 7, and 9-11; however, systems of FIGS. 7 and 10 may be modified to use reverse osmosis units.) Retentate comprising increased alkalinity and/or hardness (e.g., Ca²⁺ and/or Mg²⁺) may then be recirculated to processor 810, or a sub-system thereof, and processed with the industrial source of carbon dioxide to form additional carbonates, bicarbonates, or carbonates and bicarbonates. In some embodiments, permeate may be provided to an electrochemical system (as shown in, for example, FIGS. 7 and 10) or desalinated. In some embodiments, as shown in FIG. 8, permeate comprising monovalent ions (e.g., Na⁺, Cl⁻) may be passed through filtration unit 828C (e.g., reverse osmosis unit) to separate the previous filtration unit permeate into a permeate comprising monovalent ions (e.g., Na⁺, Cl⁻) and a retentate comprising multivalent ions (e.g., divalent cations such as Ca²⁺ and/or Mg²⁺), both of which may be used in electrochemical system 850 as shown. In some embodiments, either the permeate, the retentate, or both are demineralized and optionally concentrated before being provided to the electrochemical system. The electrochemical system, as described herein, may be used to produce an aqueous solution comprising proton-removing agents (e.g., NaOH (aq)) and another aqueous solution comprising acid (e.g., HCl (aq)). The aqueous solution comprising acid may be provided to any of a number of acid-utilizing processes, including, but not limited to, raw material processing in a raw material processing unit (e.g., raw material processing unit 570 of FIG. 5) configured to digest magnesium silicates (e.g., serpentine, olivine, etc.) with HCl (aq) and to produce divalent cations (e.g., Mg²⁺) for subsequent use in preparing compositions of the invention or for use as rock salt (e.g., MgCl₂) and sand (SiO₂), which may be used together or separately to melt ice on roads.

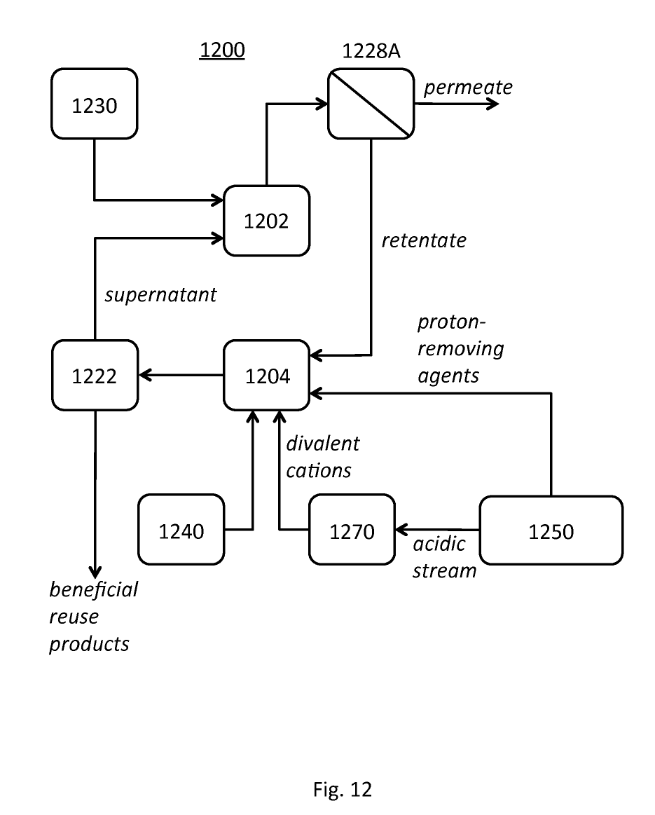

FIG. 12 provides yet another embodiment of a system of the invention. In such embodiments, a filtration unit (1228A) may be inserted between contactor 1202 (e.g., gas-liquid or gas-liquid-solid contactor) and a reactor (1204). As such, the processor (e.g., the contactor in combination with the reactor) of such systems is configured with an intermediate filtration unit (e.g., nanofiltration unit). As shown, the contactor may be operably connected to a source of CO₂-containing gas (1230) and a dewatering system (1222) and adapted for processing CO₂-containing gas with supernatant received from the dewatering system to produce compositions comprising carbonate, bicarbonates, or carbonates and bicarbonates. The filtration unit (e.g., nanofiltration unit), which is operably connected to both the contactor and the reactor, may be configured to filter the contactor effluent (e.g., composition comprising carbonates, bicarbonate, or carbonates and bicarbonates) such that monovalent ions (e.g., Na⁺, Cl⁻) are allowed to pass through as permeate while multivalent ions (e.g., Ca²⁺, Mg²⁺, or combinations thereof) are rejected as retentate. For example, in some embodiments, the filtration unit is a nanofiltration unit configured with a nanofiltration membrane. The reactor, which is operably connected to each of a source of alkalinity (1240), a raw material processor (1270), an electrochemical system (1250), and the filtration unit, may be configured for further processing of the composition produced in the contactor and concentrated in the filtration unit. In some embodiments, for example, the contactor may be configured to produce a composition comprising mostly bicarbonates. In such exemplary embodiments, the filtration unit may be configured to produce a concentrated composition, wherein the concentrated composition is concentrated with respect to bicarbonates and multivalent ions (e.g., divalent cations such as Ca²⁺ and/or Mg²⁺). The reactor, in turn, may be configured to process the concentrated composition to produce a composition comprising mostly carbonates. The foregoing illustrates an exemplary embodiment featuring the contactor, the filtration unit, and the reactor as each may be configured to provide for a different reactor composition. For example, the reactor, as shown, may be configured to receive proton-removing agents from the electrochemical system (1250), divalent cations from the raw material processor (1270), and alkalinity from the source of alkalinity (1240), each of which may affect the reactor composition. As with other systems of the invention, the reactor (or processor) may be operably connected to a dewatering system of the invention. As shown in FIG. 12, the dewatering system may be configured to recirculate supernatant to the contactor and provide beneficial reuse products.

Methods relating to processing carbon dioxide with a system such as the system of FIG. 12 are also provided. As such, in some embodiments, a source of CO₂-containing gas (1230) and supernatant from a dewatering system (1222) may be provided to contactor 1202 (e.g., gas-liquid or gas-liquid contactor) to produce a composition comprising carbonates, bicarbonates, or carbonates and bicarbonates. As shown in FIG. 12, the composition from the contactor may then be provided to a filtration unit (e.g., a nanofiltration unit). The filter unit, as described above, may be configured to filter the composition from the contactor to produce a permeate and a retentate. As such, in methods of the invention, the composition from the contactor may be treated in the filtration unit such that monovalent ions (e.g., Na⁺, Cl⁻) of the composition are allowed to pass through the filtration unit as permeate while multivalent ions (e.g., Ca²⁺, Mg²⁺, or combinations thereof) are rejected as retentate. Such treatment allows for a reduction in, for example, sodium chloride in compositions of the invention, which may be advantageous for certain end products (e.g., cement comprising precipitation material of the invention). The filtration unit-treated composition may then be provided to a reactor (1204), wherein the additional divalent cations from raw material processing, additional alkalinity, or proton-removing agents may be added. Depending on available materials (e.g., raw materials for processing, source of alkalinity, etc.) different compositions may be prepared in the reactor of carbon dioxide-processing system 1200. In some embodiments, for example, sufficient divalent cations (e.g., Ca²⁺, Mg²⁺, or a combination thereof) may be provided to the reactor from the raw material processor (1270) and the source of alkalinity such that a slurry comprising a precipitation material (e.g., CaCO₃, MgCO₃, or a combination thereof) may be produced. Such slurries may be provided to dewatering systems of the invention and separated into a supernatant for reuse in the contactor and a precipitation material for beneficial reuse products.

Systems of the invention may further comprise a demineralization system comprising any of a number of demineralization units, including demineralization units selected from precipitators and ion exchange units. A demineralization system of the invention may be configured in any way to effect a sufficient level of demineralization for use of filtration unit retentate or filtration unit permeate in other systems or units of the invention. For example, in some embodiments a demineralization system is configured to provide demineralized filtration unit retentate to an electrochemical system of the invention. In another exemplary embodiment, a demineralization system may be configured to provide demineralized filtration unit permeate to an electrochemical system. In such embodiments, demineralization system may be configured to provide filtration unit retentate or permeate to a precipitator, which, in turn, is configured to provide the resulting composition to the ion exchange unit. In another configuration, a demineralization system may be configured to provide filtration unit retentate or permeate to an ion exchange unit, which, in turn, is configured to provide the resulting composition to a precipitator. In some embodiments, the demineralized retentate or permeate is provided to a concentrator configured for concentrating the retentate or permeate prior to processing by the electrochemical system.

Regarding methods of deminerization and/or concentration, in some embodiments, the method further comprises demineralizing at least a portion of filtration unit retentate to produce a demineralized filtration unit retentate. For the purpose of the invention, demineralized filtration unit retenate may be retentate in which Ca²⁺, Mg²⁺, or a combination thereof have been removed. In some embodiments, Ca²⁺ and/or Mg²⁺ are removed as Ca(OH)₂ and/or Mg(OH)₂ by precipitation in the precipitator using, for example, NaOH. In some embodiments, Ca²⁺ and/or Mg²⁺ are removed by ion exchange in the ion exchange unit using, for example, Amberlite®IRC747. In some embodiments Ca²⁺ and/or Mg²⁺ are removed by precipitation as Ca(OH)₂ and/or Mg(OH)₂ followed by ion exchange. In some embodiments, Ca²⁺ and/or Mg²⁺ are removed by ion exchange followed by precipitation as Ca(OH)₂ and/or Mg(OH)₂. In some embodiments, demineralized filtration unit retentate may be used in an electrochemical process to produce proton-removing agents. In some embodiments, demineralized filtration unit retentate is concentrated prior to use in an electrochemical process to produce proton-removing agents. In some embodiments, the method further comprises demineralizing at least a portion of filtration unit permeate to produce a demineralized filtration unit permeate. For the purpose of the invention, demineralized filtration unit permeate may be permeate in which Ca²⁺, Mg²⁺, or a combination thereof have been removed. In some embodiments, Ca²⁺ and/or Mg²⁺ are removed by precipitation as Ca(OH)₂ and/or Mg(OH)₂. In some embodiments, Ca²⁺ and/or Mg²⁺ are removed by ion exchange. In some embodiments Ca²⁺ and/or Mg²⁺ are removed by precipitation as Ca(OH)₂ and/or Mg(OH)₂ followed by ion exchange. In some embodiments, Ca²⁺ and/or Mg²⁺ are removed by ion exchange followed by precipitation as Ca(OH)₂ and/or Mg(OH)₂. In some embodiments, demineralized filtration unit permeate may be used in an electrochemical process to produce proton-removing agents. In some embodiments, demineralized filtration unit permeate is concentrated prior to use in an electrochemical process to produce proton-removing agents.

### Carbon Dioxide

Embodiments of the invention provide for methods of contacting a source of alkalinity with a source of carbon dioxide, then subjecting the carbon dioxide-charged solution to conditions suitable for production of a composition comprising carbonates, bicarbonates, or carbonates and bicarbonates. Such conditions may also be suitable for production of a composition comprising an isolable precipitation material (e.g., CaCO₃, MgCO₃). In some embodiments, the invention provides methods of contacting a source of alkalinity with a source of carbon dioxide while subjecting the solution to conditions suitable for production of a composition comprising carbonates, bicarbonates, or carbonates and bicarbonates, including production of compositions comprising isolable precipitation material. The source of carbon dioxide may be any convenient source of carbon dioxide, and the source may be in any convenient form (e.g., a gas, a liquid, a solid, a supercritical fluid, or dissolved in a liquid such as water). In some embodiments, the source of carbon dioxide is in the form of a gas. For example, the source of carbon dioxide may be an industrial waste stream (e.g., a gaseous waste stream) from a coal-fired power plant or a cement plant. The industrial waste stream may be substantially pure carbon dioxide or comprise multiple components in addition to carbon dioxide, wherein the multiple components may comprise one or more additional gases (e.g., nitrogen), particulate matter such as ash, or some combination thereof. In some embodiments, the source of carbon dioxide is an industrial waste stream such as exhaust from an industrial plant. The nature of the industrial plant may vary, the industrial plants including, but not limited to, power plants, chemical processing plants, mechanical processing plants, refineries, cement plants, steel plants, and other industrial plants that produce carbon dioxide as a by-product of fuel combustion or another processing step (e.g., calcination by a cement plant).

Gaseous waste streams comprising carbon dioxide include both reducing (e.g., syngas, shifted syngas, natural gas, hydrogen and the like) and oxidizing condition streams (e.g., flue gases from combustion). Particular gaseous waste streams that may be convenient for the invention include oxygen-containing waste streams resulting from combustion of fossil fuels (e.g., coal or another carbon-based fuel with little or no pretreatment), turbo charged boiler product gas, coal gasification product gas, pre-combustion synthesis gas streams such as those formed during coal gasification in power generating plants, shifted coal gasification product gas, anaerobic digester product gas, wellhead natural gas stream, reformed natural gas or methane hydrates, and the like. Gaseous waste from any convenient combustion process may be used in methods and systems of the invention. In some embodiments, gaseous waste from post-combustion effluent stacks of industrial plants such as power plants, cement plants, and coal processing plants may be used.

Thus, gaseous waste streams may be produced from a variety of different types of industrial plants. Suitable gaseous waste streams include waste streams produced by industrial plants that combust fossil fuels (e.g., coal, oil, natural gas, propane, diesel) and anthropogenic fuel products of naturally occurring organic fuel deposits (e.g., tar sands, heavy oil, oil shale, etc.). In some embodiments, a gaseous waste stream suitable for systems and methods of the invention is sourced from a coal-fired power plant, such as a pulverized coal power plant, a supercritical coal power plant, a mass burn coal power plant, and a fluidized bed coal power plant. In some embodiments, the gaseous waste stream is sourced from gas- or oil-fired boiler and steam turbine power plants, gas- or oil-fired boiler simple cycle gas turbine power plants, or gas- or oil-fired boiler combined cycle gas turbine power plants. In some embodiments, gaseous waste streams produced by power plants that combust syngas (i.e., gas that is produced by the gasification of organic matter, for example, coal, biomass, etc.) may be used. In some embodiments, gaseous waste streams from integrated gasification combined cycle (IGCC) plants are used. In some embodiments, gaseous waste streams produced by Heat Recovery Steam Generator (HRSG) plants are used in accordance with systems and methods of the invention.

Gaseous waste streams produced by cement plants are also suitable for the invention. Gaseous waste streams of cement plant include waste streams from both wet process and dry process plants, which plants may employ shaft kilns or rotary kilns and may include pre-calciners. These industrial plants may each burn a single fuel, or may burn two or more fuels, sequentially or simultaneously. Other industrial plants such as smelters and refineries are also useful sources of gaseous waste streams that include carbon dioxide.

Gaseous waste streams may contain carbon dioxide as the primary non-air derived component, or may, especially in the case of coal-fired power plants, contain additional components such as nitrogen oxides (NOx), sulfur oxides (SOx), and any of a number of additional gases and/or components. Additional gases and/or other components may include CO, mercury and other heavy metals, and dust particles (e.g., from calcining and combustion processes). Other components in the gaseous waste stream may also include halides such as hydrogen chloride and hydrogen fluoride; particulate matter such as fly ash, dusts, and metals including arsenic, beryllium, boron, cadmium, chromium, chromium VI, cobalt, lead, manganese, mercury, molybdenum, selenium, strontium, thallium, and vanadium; and organics such as hydrocarbons, dioxins, and PAH compounds. Suitable gaseous waste streams that may be treated have, in some embodiments, carbon dioxide, SOx (i.e., monosulfur oxides including SO, SO₂, and SO₃), VOC (volatile organic compounds), heavy metals such as mercury, and particulate matter (particles of solid or liquid suspended in a gas). Flue gas temperatures may also vary. In some embodiments, the temperature of a flue gas comprising carbon dioxide may be from 0° C. to 2000° C., such as from 60° C. to 700° C., including 100° C. to 400° C., for example 100° C. to 200° C. Gaseous waste streams of interest have, in certain embodiments, carbon dioxide present in amounts of 200 ppm to 1,000,000 ppm, such as 200,000 ppm to 1000 ppm, including 200,000 ppm to 2000 ppm, for example 180,000 ppm to 2000 ppm, or 180,000 ppm to 5000 ppm, also including 180,000 ppm to 10,000 ppm. The gaseous waste streams, particularly various waste streams of combustion gas, may include one or more additional components, for example, water, NOx (i.e., mononitrogen oxides such as NO and NO₂), SOx (i.e., monosulfur oxides such as SO, SO₂, and SO₃), VOC (Volatile organic compounds), heavy metals such as mercury, and particulate matter (particles of solid or liquid suspended in a gas).

In some embodiments, one or more additional components or co-products (i.e., products produced from other starting materials [e.g., SOx, NOx, etc.] under the same conditions employed to convert carbon dioxide into carbonates, bicarbonates, or carbonates and bicarbonates) are produced. In some embodiments, the one or more additional components are precipitated or trapped in precipitation material formed by contacting the gaseous waste stream comprising these additional components with a source of alkalinity comprising divalent cations of alkaline earth metals (e.g., Ca²⁺, Mg²⁺). Sulfates, sulfites, and the like of calcium and/or magnesium may be formed and, in some embodiments, precipitated or trapped in precipitation material comprising calcium and/or magnesium carbonates when the gaseous waste stream comprises SOx (e.g., SO₂). In such embodiments, magnesium and calcium may react to form MgSO₄ and CaSO₄, respectively, as well as other magnesium-containing and calcium-containing compounds (e.g., sulfites), effectively removing sulfur from the flue gas stream without a desulfurization step such as flue gas desulfurization (“FGD”). In addition, CaCO₃, MgCO₃, and related compounds may be formed without additional release of carbon dioxide. In instances where a source of alkalinity comprising divalent cations contains high levels of sulfur compounds (e.g., sulfate), the alkaline solution may be enriched with calcium and magnesium such that calcium and magnesium may be available to form carbonate compounds after, or in addition to, formation of CaSO₄, MgSO₄, and related compounds. In some embodiments, a desulfurization step may be staged to coincide with preparation of the composition comprising carbonates, bicarbonates, or carbonates and bicarbonates. In some embodiments, a desulfurization step may be staged to occur prior to preparation of the composition comprising carbonates, bicarbonates, or carbonates and bicarbonates. In some embodiments, a desulfurization step may be staged to coincide with precipitation of a carbonate-containing precipitation material, or the desulfurization step may be staged to occur before the precipitation. In some embodiments, multiple reaction products (e.g., MgCO₃, CaCO₃, CaSO₄, mixtures of the foregoing, and the like) are collected at different stages of processing the gaseous waste stream comprising carbon dioxide. In some embodiments, a single reaction product (e.g., precipitation material comprising carbonates, sulfates, etc.) is collected. In step with these embodiments, other components of the gaseous waste stream comprising carbon dioxide, such as heavy metals (e.g., mercury, mercury salts, mercury-containing compounds), may become part of the composition comprising carbonates, bicarbonates, or carbonates and bicarbonates. In some embodiments, other components of the gaseous waste stream comprising carbon dioxide, such as heavy metals (e.g., mercury, mercury salts, mercury-containing compounds), may be trapped in precipitation material comprising carbonates, bicarbonates, or carbonates and bicarbonates. Alternatively, such heavy metals may be processed and precipitated separately.

A portion of the gaseous waste stream (i.e., not the entire gaseous waste stream) from an industrial plant may be used to produce compositions of the invention (e.g., precipitation material). In these embodiments, the portion of the gaseous waste stream that is employed may be 75% or less, such as 60% or less, and including 50% and less of the gaseous waste stream. In yet other embodiments, substantially (e.g., 80% or more) the entire gaseous waste stream produced by the industrial plant may be used to produce compositions of the invention (e.g., precipitation of precipitation material). In these embodiments, 80% or more, such as 90% or more, including 95% or more, up to 100% of the gaseous waste stream (e.g., flue gas) generated by the industrial point source may be used to produce compositions of the invention.

Although industrial waste gas offers a relatively concentrated source of combustion gases, methods and systems of the invention are also applicable to removing combustion gas components from less concentrated sources (e.g., atmospheric air), which may contain a much lower concentration of pollutants than, for example, flue gas. Thus, in some embodiments, methods and systems encompass decreasing the concentration of pollutants in atmospheric air by producing a composition (e.g., precipitation material) comprising carbonates, bicarbonates, or carbonates and bicarbonates. In these cases, the concentration of pollutants (e.g., carbon dioxide) in a portion of atmospheric air may be decreased by 10% or more, 20% or more, 30% or more, 40% or more, 50% or more, 60% or more, 70% or more, 80% or more, 90% or more, 95% or more, 99% or more, 99.9% or more, or 99.99%. Such decreases in atmospheric pollutants may be accomplished with yields as described herein, or with higher or lower yields, and may be accomplished in one step or in a series of steps.

### Alkalinity

Embodiments of the invention provide for methods of contacting a source of alkalinity with a source of carbon dioxide, then subjecting the carbon dioxide-charged solution to conditions suitable for production of a composition comprising carbonates, bicarbonates, or carbonates and bicarbonates. In some embodiments, the invention provides methods of contacting a source of alkalinity with a source of carbon dioxide while subjecting the solution to conditions suitable for production of a composition comprising carbonates, bicarbonates, or carbonates and bicarbonates, including production of compositions comprising isolable precipitation material. As many sources of alkalinity also comprise divalent cations (e.g., Ca²⁺, Mg²⁺), the foregoing conditions may also be suitable for production of a composition comprising an isolable precipitation material (e.g., CaCO₃, MgCO₃). The source of alkalinity, which may also comprise divalent cations, may come from any of a number of different sources depending upon availability at a particular location. Such sources include, but are not limited to, industrial wastes, seawater, brines, hard waters, freshwater comprising digested rocks and minerals (e.g., lime, periclase, material comprising metal silicates such as serpentine and olivine, etc.), and any other suitable source of alkalinity. For the purpose of the invention, sources of alkalinity, in raw form, need not exist as an aqueous solution. As such, sources of alkalinity may comprise, for example, fossil fuel-burning ash such as fly ash, bottom ash, or boiler slag, with the understanding that such substances, when processed with water, provide sources of alkalinity.

In some locations, industrial waste streams from various industrial processes provide for convenient sources of alkalinity, as well as, in some embodiments, sources of divalent cations and/or proton-removing agents (e.g., metal hydroxides). Such waste streams include, but are not limited to, mining wastes; fossil fuel burning ash (e.g., combustion ash such as fly ash, bottom ash, boiler slag); slag (e.g. iron slag, phosphorous slag); cement kiln waste; oil refinery/petrochemical refinery waste (e.g. oil field and methane seam brines); coal seam wastes (e.g. gas production brines and coal seam brine); paper processing waste; water softening waste brine (e.g., ion exchange effluent); silicon processing wastes; agricultural waste; metal finishing waste; high pH textile waste; and caustic sludge. Fossil fuel-burning ash, cement kiln dust, and slag, collectively waste sources of metal oxides, further described in U.S. patent application Ser. No. 12/486,692, filed 17 Jun. 2009, which is incorporated herein by reference in its entirety, may be used in any combination with material comprising metal silicates, further described in U.S. patent application Ser. No. 12/501,217, filed 10 Jul. 2009, which is also incorporated herein by reference in its entirety. Any of the sources of alkalinity described herein may be mixed and matched for the purpose of practicing the invention. For example, material comprising metal silicates (e.g. serpentine, olivine) may be combined with any of the sources of alkalinity described herein for the purpose of practicing the invention.

In some locations, a convenient source of alkalinity for preparation of compositions of the invention is water (e.g., an aqueous solution seawater or surface brine), which may vary depending upon the particular location at which the invention is practiced. Suitable sources of alkalinity that may be used include solutions comprising one or more divalent cations (e.g., alkaline earth metal cations such as Ca²⁺ and Mg²⁺). In some embodiments, the source of alkalinity comprises divalent cations, wherein the divalent cations comprise alkaline earth metal cations. In some embodiments, the alkaline earth metal cations include calcium, magnesium, or a combination thereof. In some embodiments, the source of alkalinity comprises calcium in amounts ranging from 50 to 50,000 ppm, 50 to 40,000 ppm, 50 to 20,000 ppm, 100 to 10,000 ppm, 200 to 5000 ppm, or 400 to 1000 ppm. In some embodiments, the source of alkalinity comprises magnesium in amounts ranging from 50 to 40,000 ppm, 50 to 20,000 ppm, 100 to 10,000 ppm, 200 to 10,000 ppm, 500 to 5000 ppm, or 500 to 2500 ppm. In some embodiments, where Ca²⁺ and Mg²⁺ are both present, the ratio of Ca²⁺ to Mg²⁺ (i.e., Ca²⁺:Mg²) in the source of alkalinity is between 1:1 and 1:2.5; 1:2.5 and 1:5; 1:5 and 1:10; 1:10 and 1:25; 1:25 and 1:50; 1:50 and 1:100; 1:100 and 1:150; 1:150 and 1:200; 1:200 and 1:250; 1:250 and 1:500; 1:500 and 1:1000, or a range thereof. For example, in some embodiments, the ratio of Ca²⁺ to Mg²⁺ in the source of alkalinity is between 1:1 and 1:10; 1:5 and 1:25; 1:10 and 1:50; 1:25 and 1:100; 1:50 and 1:500; or 1:100 and 1:1000. In some embodiments, the ratio of Mg²⁺ to Ca²⁺ (i.e., Mg²⁺:Ca²⁺) in the source of alkalinity is between 1:1 and 1:2.5; 1:2.5 and 1:5; 1:5 and 1:10; 1:10 and 1:25; 1:25 and 1:50; 1:50 and 1:100; 1:100 and 1:150; 1:150 and 1:200; 1:200 and 1:250; 1:250 and 1:500; 1:500 and 1:1000, or a range thereof. For example, in some embodiments, the ratio of Mg²⁺ to Ca²⁺ in the source of alkalinity is between 1:1 and 1:10; 1:5 and 1:25; 1:10 and 1:50; 1:25 and 1:100; 1:50 and 1:500; or 1:100 and 1:1000.

The source of alkalinity may comprise freshwater, brackish water, seawater, or brine (e.g., naturally occurring brines or anthropogenic brines such as geothermal plant wastewaters, desalination plant waste waters), as well as other salines having a salinity that is greater than that of freshwater, any of which may be naturally occurring or anthropogenic, and any of which may contain divalent cations. Brackish water is water that is saltier than freshwater, but not as salty as seawater. Brackish water has a salinity ranging from about 0.5 to about 35 ppt (parts per thousand). Seawater is water from a sea, an ocean, or any other saline body of water that has a salinity ranging from about 35 to about 50 ppt. Brine is water saturated or nearly saturated with salt. Brine has a salinity that is about 50 ppt or greater. In some embodiments, the source of alkalinity is a mineral rich (e.g., calcium-rich and/or magnesium-rich) freshwater source. In some embodiments, the source of alkalinity is a naturally occurring saltwater source selected from a sea, an ocean, a lake, a swamp, an estuary, a lagoon, a surface brine, a deep brine, an alkaline lake, an inland sea, or the like. In some embodiments, the source of alkalinity is a surface brine. In some embodiments, the source of alkalinity is a subsurface brine. In some embodiments, the source of alkalinity is a deep brine. In some embodiments, the source of alkalinity is a Ca—Mg—Na—(K)—Cl; Na—(Ca)—SO₄—Cl; Mg—Na—(Ca)—SO₄—Cl; Na—CO₃—Cl; or Na—CO₃—SO₄—Cl brine, or an evaporite thereof, as described in U.S. Provisional Patent Application No. 61/264,564, filed 25 Nov. 2009, titled “Methods and Systems for Utilizing Salts.” In some embodiments, the source of alkalinity is an anthropogenic brine selected from a geothermal plant wastewater or a desalination wastewater.

Freshwater is often a convenient source of alkalinity, which may further comprise divalent cations of alkaline earth metals such as Ca²⁺ and Mg²⁺. Any of a number of suitable freshwater sources may be used, including freshwater sources ranging from sources relatively free of minerals to sources relatively rich in minerals. Mineral-rich freshwater sources may be naturally occurring, including any of a number of hard water sources, lakes, (e.g., alkaline lakes), or inland seas (e.g., Lake Van in Turkey). Mineral-rich freshwater sources may also be anthropogenic. For example, a mineral-poor (soft) water may be contacted with a source of divalent cations such as alkaline earth metal cations (e.g., Ca²⁺, Mg²⁺, etc.) to produce a mineral-rich water that is suitable for systems and methods described herein. Salts, minerals, and the like may be added to freshwater (or any other type of water described herein) using any convenient protocol (e.g., addition of solids, suspensions, or solutions) to provide a source of alkalinity for the invention. In some embodiments, divalent cations selected from Ca²⁺ and Mg²⁺ are added to freshwater, resulting in a source of alkalinity comprising Ca²⁺ and/or Mg²⁺. In some embodiments, monovalent cations selected from Na⁺ and K⁻ are added to freshwater, resulting in a source of alkalinity comprising Na⁺ and/or K⁺. In some embodiments, freshwater comprising Ca²⁺ is combined with material comprising metal silicates, combustion ash (e.g., fly ash, bottom ash, boiler slag), or products or processed forms thereof, including combinations of the foregoing, yielding a source of alkalinity comprising calcium and magnesium cations.

In some embodiments, a source of alkalinity may be obtained from an industrial plant that is also providing a gaseous waste stream. For example, in water-cooled industrial plants, such as seawater-cooled industrial plants, water that has been used by an industrial plant for cooling may then be used as water for producing compositions of the invention (e.g., precipitation material comprising carbonate, bicarbonates, or carbonates and bicarbonates). If desired, the water may be cooled prior to entering a processor or processor sub-system (e.g., gas-liquid contactor, gas-liquid-solid contactor) of the invention. Such approaches may be employed, for example, with once-through cooling systems. For example, a city or agricultural water supply may be employed as a once-through cooling system for an industrial plant. Water from the industrial plant may then be employed for producing compositions of the invention (e.g., precipitation material), wherein output water has a reduced hardness and greater purity.

### Proton-Removing Agents and Methods for Effecting Proton Removal

Methods of the invention include contacting a source of alkalinity with a source of CO₂, then subjecting the carbon dioxide-charged solution to conditions suitable for production of a composition comprising carbonates, bicarbonates, or carbonates and bicarbonates. Such conditions may also be suitable for production of a composition comprising an isolable precipitation material (e.g., CaCO₃, MgCO₃). In some embodiments, the invention provides methods of contacting a source of alkalinity with a source of carbon dioxide while subjecting the solution to conditions suitable for production of a composition comprising carbonates, bicarbonates, or carbonates and bicarbonates, including production of compositions comprising isolable precipitation material. Without being bound by theory, contacting a source of alkalinity with a source of CO₂ leads to the dissolution of CO₂ into the source of alkalinity and produces carbonic acid, a species in equilibrium with both bicarbonate and carbonate. In order to produce an isolable precipitation material comprising carbonates, protons are removed from various species (e.g. carbonic acid, bicarbonate, hydronium, etc.) in the solution that comprises a source of alkalinity and dissolved CO₂ in order to shift the equilibrium toward carbonate. As protons are removed, more CO₂ goes into solution. In some embodiments, proton-removing agents and/or methods are used while contacting a source of alkalinity with a source of CO₂ to increase CO₂ absorption in one phase of the precipitation reaction, wherein the pH may remain constant, increase, or even decrease, followed by a rapid removal of protons (e.g., by addition of a base) to cause rapid precipitation of carbonate-containing precipitation material. In some embodiments, proton-removing agents and/or methods are used to control the growth of one particular polymorph of carbonate and thus dictate the final composition comprising carbonates, bicarbonates, or carbonates and bicarbonates. In some embodiments, proton-removing agents and/or methods are used to favor the formation of bicarbonate and thus dictate the final composition comprising carbonates, bicarbonates, or carbonates and bicarbonates. Protons may be removed from the various species (e.g. carbonic acid, bicarbonate, hydronium, etc.) by any convenient approach, including, but not limited to use of naturally occurring proton-removing agents, use of microorganisms and fungi, use of synthetic chemical proton-removing agents, recovery of man-made waste streams, and using electrochemical means.

Naturally occurring proton-removing agents encompass any proton-removing agents that can be found in the wider environment that may create or have a basic local environment. Some embodiments provide for naturally occurring proton-removing agents including minerals that create basic environments upon addition to solution. Such minerals include, but are not limited to, lime (CaO); periclase (MgO); iron hydroxide minerals (e.g., goethite and limonite); and volcanic ash. Methods for digestion of such minerals and rocks comprising such minerals are provided herein. Some embodiments provide for using naturally occurring bodies of water as a source proton-removing agents, which bodies of water comprise carbonate, borate, sulfate, or nitrate alkalinity, or some combination thereof. Any alkaline brine (e.g., surface brine, subsurface brine, a deep brine, etc.) is suitable for use in the invention both as a source of alkalinity and as a source of proton-removing agents. In some embodiments, a surface brine comprising carbonate alkalinity provides a source of proton-removing agents. In some embodiments, a surface brine comprising borate alkalinity provides a source of proton-removing agents. In some embodiments, a subsurface brine comprising carbonate alkalinity provides a source of proton-removing agents. In some embodiments, a subsurface brine comprising borate alkalinity provides a source of proton-removing agents. In some embodiments, a deep brine comprising carbonate alkalinity provides a source of proton-removing agents. In some embodiments, a deep brine comprising borate alkalinity provides a source of proton-removing agents. Examples of naturally alkaline bodies of water include, but are not limited to surface water sources (e.g. alkaline lakes such as Mono Lake in California) and ground water sources (e.g. basic aquifers such as the deep geologic alkaline aquifers located at Searles Lake in California). Other embodiments provide for use of deposits from dried alkaline bodies of water such as the crust along Lake Natron in Africa's Great Rift Valley. In some embodiments, organisms that excrete basic molecules or solutions in their normal metabolism are used as proton-removing agents. Examples of such organisms are fungi that produce alkaline protease (e.g., the deep-sea fungus Aspergillus ustus with an optimal pH of 9) and bacteria that create alkaline molecules (e.g., cyanobacteria such as Lyngbya sp. from the Atlin wetland in British Columbia, which increases pH from a byproduct of photosynthesis). In some embodiments, organisms are used to produce proton-removing agents, wherein the organisms (e.g., Bacillus pasteurii, which hydrolyzes urea to ammonia) metabolize a contaminant (e.g. urea) to produce proton-removing agents or solutions comprising proton-removing agents (e.g., ammonia, ammonium hydroxide). In some embodiments, organisms are cultured separately from the precipitation reaction mixture, wherein proton-removing agents or solution comprising proton-removing agents are used for addition to the precipitation reaction mixture. In some embodiments, naturally occurring or manufactured enzymes are used in combination with proton-removing agents to invoke formation of a composition comprising carbonates, bicarbonates, or carbonates and bicarbonates (e.g. precipitation material). Carbonic anhydrase, which is an enzyme produced by plants and animals, accelerates transformation of carbonic acid to bicarbonate in aqueous solution. As such, carbonic anhydrase may be used to enhance dissolution of CO₂ and accelerate formation of a composition comprising carbonates, bicarbonates, or carbonates and bicarbonates (e.g., precipitation material), as described in further detail in U.S. Provisional Application No. 61/252,929, titled, “Methods and systems for treating industrial waste gases,” filed 19 Oct. 2009.

Chemical agents for effecting proton removal generally refer to synthetic chemical agents that are produced in large quantities and are commercially available. For example, chemical agents for removing protons include, but are not limited to, hydroxides, organic bases, super bases, oxides, ammonia, and carbonates. Hydroxides include chemical species that provide hydroxide anions in solution, including, for example, sodium hydroxide (NaOH), potassium hydroxide (KOH), calcium hydroxide (Ca(OH)₂), or magnesium hydroxide (Mg(OH)₂). Organic bases are carbon-containing molecules that are generally nitrogenous bases including primary amines such as methyl amine, secondary amines such as diisopropylamine, tertiary such as diisopropylethylamine, aromatic amines such as aniline, heteroaromatics such as pyridine, imidazole, and benzimidazole, and various forms thereof. In some embodiments, an organic base selected from pyridine, methylamine, imidazole, benzimidazole, histidine, and a phophazene is used to remove protons from various species (e.g., carbonic acid, bicarbonate, hydronium, etc.) for formation of a composition comprising carbonates, bicarbonates, or carbonates and bicarbonates (e.g., precipitation material). In some embodiments, ammonia is used to raise pH to a level sufficient to form a composition comprising carbonates, bicarbonates, or carbonates and bicarbonates (e.g., precipitation material) from a solution of divalent cations and an industrial waste stream. Super bases suitable for use as proton-removing agents include sodium ethoxide, sodium amide (NaNH₂), sodium hydride (NaH), butyl lithium, lithium diisopropylamide, lithium diethylamide, and lithium bis(trimethylsilyl)amide. Oxides including, for example, calcium oxide (CaO), magnesium oxide (MgO), strontium oxide (SrO), beryllium oxide (BeO), and barium oxide (BaO) are also suitable proton-removing agents that may be used. Carbonates for use in the invention include, but are not limited to, sodium carbonate.

In addition to comprising cations of interest and other suitable metal forms, waste streams from various industrial processes may provide proton-removing agents. Such waste streams include, but are not limited to, mining wastes; fossil fuel burning ash (e.g., combustion ash such as fly ash, bottom ash, boiler slag); slag (e.g. iron slag, phosphorous slag); cement kiln waste; oil refinery/petrochemical refinery waste (e.g. oil field and methane seam brines); coal seam wastes (e.g. gas production brines and coal seam brine); paper processing waste; water softening waste brine (e.g., ion exchange effluent); silicon processing wastes; agricultural waste; metal finishing waste; high pH textile waste; and caustic sludge. Mining wastes include any wastes from the extraction of metal or another precious or useful mineral from the earth. In some embodiments, wastes from mining are used to modify pH, wherein the waste is selected from red mud from the Bayer aluminum extraction process; waste from magnesium extraction from seawater (e.g., Mg(OH)₂ such as that found in Moss Landing, Calif.); and wastes from mining processes involving leaching. For example, red mud may be used to modify pH as described in U.S. Provisional Patent Application No. 61/161,369, filed 18 Mar. 2009, which is incorporated herein by reference in its entirety. Fossil fuel burning ash, cement kiln dust, and slag, collectively waste sources of metal oxides, further described in U.S. patent application Ser. No. 12/486,692, filed 17 Jun. 2009, the disclosure of which is incorporated herein in its entirety, may be used in alone or in combination with other proton-removing agents to provide proton-removing agents for the invention. Agricultural waste, either through animal waste or excessive fertilizer use, may contain potassium hydroxide (KOH) or ammonia (NH₃) or both. As such, agricultural waste may be used in some embodiments of the invention as a proton-removing agent. This agricultural waste is often collected in ponds, but it may also percolate down into aquifers, where it can be accessed and used.

Electrochemical methods are another means to remove protons from various species in a solution, either by removing protons from solute (e.g., deprotonation of carbonic acid or bicarbonate) or from solvent (e.g., deprotonation of hydronium or water). Deprotonation of solvent may result, for example, if proton production from CO₂ dissolution matches or exceeds electrochemical proton removal from solute molecules. In some embodiments, low-voltage electrochemical methods are used to remove protons, for example, as CO₂ is contacted with and dissolved in the source of alkalinity. In some embodiments, CO₂ dissolved in an aqueous solution that does not contain a source of alkalinity is treated by a low-voltage electrochemical method to remove protons from carbonic acid, bicarbonate, hydronium, or any species or combination thereof resulting from the dissolution of CO₂. A low-voltage electrochemical method operates at an average voltage of 2, 1.9, 1.8, 1.7, or 1.6 V or less, such as 1.5, 1.4, 1.3, 1.2, 1.1 V or less, such as 1 V or less, such as 0.9 V or less, 0.8 V or less, 0.7 V or less, 0.6 V or less, 0.5 V or less, 0.4 V or less, 0.3 V or less, 0.2 V or less, or 0.1 V or less. Low-voltage electrochemical methods that do not generate chlorine gas are convenient for use in systems and methods of the invention. Low-voltage electrochemical methods to remove protons that do not generate oxygen gas are also convenient for use in systems and methods of the invention. In some embodiments, low-voltage methods do not generate any gas at the anode. In some embodiments, low-voltage electrochemical methods generate hydrogen gas at the cathode and transport it to the anode where the hydrogen gas is converted to protons. Electrochemical methods that do not generate hydrogen gas may also be convenient. In some instances, electrochemical methods to remove protons do not generate any gaseous by-byproduct. Electrochemical methods for effecting proton removal are further described in U.S. patent application Ser. No. 12/344,019, filed 24 Dec. 2008; U.S. patent application Ser. No. 12/375,632, filed 23 Dec. 2008; International Patent Application No. PCT/US08/088242, filed 23 Dec. 2008; International Patent Application No. PCT/US09/32301, filed 28 Jan. 2009; and International Patent Application No. PCT/US09/48511, filed 24 Jun. 2009, each of which are incorporated herein by reference in their entirety.

Alternatively, electrochemical methods may be used to produce caustic molecules (e.g., hydroxide) through, for example, the chlor-alkali process, or a modification thereof. Electrodes (i.e., cathodes and anodes) may be present in the apparatus containing the source of alkalinity or the CO₂-charged solution, and a selective barrier, such as a membrane, may separate the electrodes. Electrochemical systems and methods for removing protons may produce by-products (e.g., hydrogen) that may be harvested and used for other purposes. Additional electrochemical approaches that may be used in systems and methods of the invention include, but are not limited to, those described in U.S. Provisional Patent Application No. 61/081,299, filed 16 Jul. 2008, and U.S. Provisional Patent Application No. 61/091,729, filed 25 Aug. 2008, the disclosures of which are incorporated herein by reference. Combinations of the above mentioned sources of proton-removing agents and methods for effecting proton removal might be employed.

### Compositions

Compositions of the invention, as described above, may be further processed to produce compositions comprising precipitation material, which may comprise several carbonates and/or several carbonate mineral phases resulting from co-precipitation. For example, the precipitation material may comprise calcium carbonate (e.g., calcite) together with magnesium carbonate (e.g., nesquehonite). Precipitation material may also comprise a single carbonate in a single mineral phase including, but not limited to, calcium carbonate (e.g., calcite), magnesium carbonate (e.g., nesquehonite), calcium magnesium carbonate (e.g., dolomite), or a ferro-carbo-aluminosilicate. As different carbonates may be precipitated in sequence, the precipitation material may be, depending upon the conditions under which it was obtained, relatively rich (e.g., 90% to 95%) or substantially rich (e.g., 95%-99.9%) in one carbonate and/or one mineral phase, or the precipitation material may comprise an amount of other carbonates and/or other mineral phase (or phases), wherein the desired mineral phase is 50-90% of the precipitation material. It will be appreciated that, in some embodiments, the precipitation material may comprise one or more hydroxides (e.g., Ca(OH)₂, Mg(OH)₂) in addition to the carbonates. It will also be appreciated that any of the carbonates or hydroxides present in the precipitation material may be wholly or partially amorphous. In some embodiments, the carbonates and/or hydroxides are wholly amorphous.

While many different carbon-containing salts and compounds are possible due to variability of starting materials, precipitation material comprising magnesium carbonate, calcium carbonate, or combinations thereof is particularly useful. In some embodiments, the precipitation material comprises dolomite (CaMg(CO₃)₂), protodolomite, huntite (CaMg₃(CO₃)₄), and/or sergeevite (Ca₂Mg₁₁(CO₃)₁₃.H₂O), which are carbonate minerals comprising both calcium and magnesium. In some embodiments, the precipitation material comprises calcium carbonate in one or more phases selected from calcite, aragonite, vaterite, or a combination thereof. In some embodiments, the precipitation material comprises hydrated forms of calcium carbonate selected from ikaite (CaCO₃.6H₂O), amorphous calcium carbonate (CaCO₃.nH₂O), monohydrocalcite (CaCO₃.H₂O), or combinations thereof. In some embodiments, the precipitation material comprises magnesium carbonate, wherein the magnesium carbonate does not have a water of hydration. In some embodiments, the precipitation material comprises magnesium carbonate, wherein the magnesium carbonate may have any of a number of different waters of hydration selected from 1, 2, 3, 4, or more than 4 waters of hydration. In some embodiments, the precipitation material comprises 1, 2, 3, 4, or more than 4 different magnesium carbonate phases, wherein the magnesium carbonate phases differ in the number of waters of hydration. For example, precipitation material may comprise magnesite (MgCO₃), barringtonite (MgCO₃.2H₂O), nesquehonite (MgCO₃.3H₂O), lansfordite (MgCO₃.5H₂O), and amorphous magnesium carbonate. In some embodiments, precipitation material comprises magnesium carbonates that include hydroxide and waters of hydration such as artinite (MgCO₃.Mg(OH)₂.3H₂O), hydromagnesite (Mg₅(CO₃)₄(OH)₂.3H₂O), or combinations thereof. As such, precipitation material may comprise carbonates of calcium, magnesium, or combinations thereof in all or some of the various states of hydration listed herein. Precipitation rate may also influence the nature of the precipitation material with the most rapid precipitation rate achieved by seeding the solution with a desired phase. Without seeding, rapid precipitation may be achieved by, for example, rapidly increasing the pH of the precipitation reaction mixture, which results in more amorphous constituents. Furthermore, the higher the pH, the more rapid the precipitation, which precipitation results in a more amorphous precipitation material.

Adjusting major ion ratios during precipitation may influence the nature of the precipitation material. Major ion ratios have considerable influence on polymorph formation. For example, as the magnesium:calcium ratio in the processor composition increases, aragonite becomes the major polymorph of calcium carbonate in the precipitation material over low-magnesium calcite. At low magnesium:calcium ratios, low-magnesium calcite becomes the major polymorph. In some embodiments, where Ca² and Mg²⁺ are both present, the ratio of Ca²⁺ to Mg²⁺ (i.e., Ca²⁺:Mg²⁺) in the precipitation material is between 1:1 and 1:2.5; 1:2.5 and 1:5; 1:5 and 1:10; 1:10 and 1:25; 1:25 and 1:50; 1:50 and 1:100; 1:100 and 1:150; 1:150 and 1:200; 1:200 and 1:250; 1:250 and 1:500; 1:500 and 1:1000, or a range thereof. For example, in some embodiments, the ratio of Ca²⁺ to Mg²⁺ in the precipitation material is between 1:1 and 1:10; 1:5 and 1:25; 1:10 and 1:50; 1:25 and 1:100; 1:50 and 1:500; or 1:100 and 1:1000. In some embodiments, the ratio of Mg²⁺ to Ca²⁺ (i.e., Mg²⁺:Ca²⁺) in the precipitation material is between 1:1 and 1:2.5; 1:2.5 and 1:5; 1:5 and 1:10; 1:10 and 1:25; 1:25 and 1:50; 1:50 and 1:100; 1:100 and 1:150; 1:150 and 1:200; 1:200 and 1:250; 1:250 and 1:500; 1:500 and 1:1000, or a range thereof. For example, in some embodiments, the ratio of Mg²⁺ to Ca²⁺ in the precipitation material is between 1:1 and 1:10; 1:5 and 1:25; 1:10 and 1:50; 1:25 and 1:100; 1:50 and 1:500; or 1:100 and 1:1000.

As compositions of the invention are derived, at least in part, from a source of alkalinity, the compositions may include one or more additional products, co-products, or mixtures thereof indicative of the source of alkalinity. For example, if the source of alkalinity is seawater, the one or more additional products, co-products, or mixtures thereof may include chloride, sodium, sulfur, potassium, bromide, silicon, strontium, and the like. Any such markers are generally present in small concentrations such as less than 20,000 ppm, including less than 10,000 ppm, such as less than 5,000 ppm, for example, less than 2000 ppm or less than 1000 ppm. In some embodiments, the marker is strontium. In compositions comprising precipitation material, for example, CaCO₃ such as aragonite, strontium may be incorporated into the aragonite lattice at a concentration of 10,000 ppm or less. In some embodiments, precipitation material may comprise strontium in a concentration ranging from 3 to 10,000 ppm, such as from 5 to 5000 ppm, including 5 to 1000 ppm, for example, 5 to 500 ppm or 5 to 100 ppm.

In addition to compositions comprising calcium and/or magnesium, compositions of the invention may further comprise silicon, aluminum, iron, and the like. Such compositions may passively result from processing available raw materials in systems and methods of the invention; however, in other embodiments, such compositions may be deliberately prepared by addition of adjunct materials. Such compositions (i.e., compositions of the invention further comprising, for example, silicon, aluminum, iron, etc.) may be desired to alter the reactivity of cements comprising the composition, or to change the properties of cured cements and concretes made from them. For example, material comprising metal silicates (e.g., serpentine, olivine, etc.) may be processed in accordance with the invention to produce precipitation material comprising, for example, amorphous silica, amorphous aluminosilicates, crystalline silica, calcium silicates, calcium alumina silicates, etc. In some embodiments, compositions of the invention comprise carbonates (e.g., calcium carbonate, magnesium carbonate) and silica in a carbonate:silica ratio between 1:1 and 1:1.5; 1:1.5 and 1:2; 1:2 and 1:2.5; 1:2.5 and 1:3; 1:3 and 1:3.5; 1:3.5 and 1:4; 1:4 and 1:4.5; 1:4.5 and 1:5; 1:5 and 1:7.5; 1:7.5 and 1:10; 1:10 and 1:15; 1:15 and 1:20, or a range thereof. In some embodiments, the compositions of the invention comprise carbonates and silica in a carbonate:silica ratio between 1:1 and 1:5, 1:5 and 1:10, or 1:5 and 1:20. In some embodiments, compositions of the invention comprises silica and carbonates (e.g., calcium carbonate, magnesium carbonate) in a silica:carbonate ratio between 1:1 and 1:1.5; 1:1.5 and 1:2; 1:2 and 1:2.5; 1:2.5 and 1:3; 1:3 and 1:3.5; 1:3.5 and 1:4; 1:4 and 1:4.5; 1:4.5 and 1:5; 1:5 and 1:7.5; 1:7.5 and 1:10; 1:10 and 1:15; 1:15 and 1:20, or a range thereof. In some embodiments, compositions of the invention comprise silica and carbonates in a silica:carbonate ratio between 1:1 and 1:5, 1:5 and 1:10, or 1:5 and 1:20. As such, compositions of the invention may comprise a silicon-based material and at least one carbonate phase. For precipitation material, the more rapid the reaction rate, the more silicon-based material (e.g., silica) may be incorporated into the precipitation material, provided the silicon-based material is present in the reaction mixture (i.e., provided silica was not removed after digestion of material comprising metal silicates).

Compositions comprising carbonates, bicarbonates, or carbonates and bicarbonates (e.g., precipitation material comprising CaCO₃ and/or MgCO₃) derived from an industrial source of carbon dioxide, may comprise the relative carbon isotope composition (δ¹³C) of the fossil fuel (e.g., coal, oil, natural gas, etc.) from which the carbon dioxide (from combustion of the fossil fuel) was derived. The relative carbon isotope composition (δ¹³C) value with units of % (per mille) is a measure of the ratio of the concentration of two stable isotopes of carbon, namely ¹²C and ¹³C, relative to a standard of fossilized belemnite (the PDB standard).

δ¹³C %=[(¹³C/¹²C sample−¹³C/¹²C PDB standard)/(¹³C/¹²C PDB standard)]×1000

As such, the δ¹³C value for compositions of the invention serves as a fingerprint for a carbon dioxide gas source. The δ¹³C value may vary from source to source (i.e., fossil fuel source), but the δ¹³C value for compositions of the invention generally, but not necessarily, ranges between −9% to −35%. In some embodiments, the δ¹³C value for compositions of the invention ranges between −1% and −50%, between −5% and −40%, between −5% and −35%, between −7% and −40%, between −7% and −35%, between −9% and −40%, or between −9% and −35%. In some embodiments, the δ13C value for compositions of the invention is less than (i.e., more negative than)-3%, −5%, −6%, −7%, −8%, −9%, −10%, −11%, −12%, −13%, −14%, −15%, −16%, −17%, −18%, −19%, −20%, −21%, −22%, −23%, −24%, −25%, −26%, −27%, −28%, −29%, −30%, −31%, −32%, −33%, −34%, −35%, −36%, −37%, −38%, −39%, −40%, −41%, −42%, −43%, −44%, or −45%, wherein the more negative the δ¹³C value, the more rich the synthetic carbonate-containing composition is in ¹²C. Any suitable method may be used for measuring the δ¹³C value, including, but no limited to, mass spectrometry and off-axis integrated-cavity output spectroscopy (off-axis ICOS).

Precipitation material may be in a storage-stable form (which may simply be air-dried precipitation material), and may be stored above ground under exposed conditions (i.e., open to the atmosphere) without significant, if any, degradation for extended durations. In some embodiments, the precipitation material may be stable under exposed conditions for 1 year or longer, 5 years or longer, 10 years or longer, 25 years or longer, 50 years or longer, 100 years or longer, 250 years or longer, 1000 years or longer, 10,000 years or longer, 1,000,000 years or longer, or even 100,000,000 years or longer. A storage-stable form of the precipitation material may be stable under a variety of different environment conditions, for example, from temperatures ranging from −100° C. to 600° C. and humidity ranging from 0 to 100%, where the conditions may be calm, windy, or stormy. As the storage-stable form of the precipitation material undergoes little if any degradation while stored above ground under normal rainwater pH, the amount of degradation, if any, as measured in terms of CO₂ gas release from the product, does not exceed 5% per year, and in certain embodiments will not exceed 1% per year. Indeed, precipitation material provided by the invention does not release more than 1%, 5%, or 10% of its total CO₂ when exposed to normal conditions of temperature and moisture, including rainfall of normal pH for at least 1, 2, 5, 10, or 20 years, or for more than 20 years, for example, for more than 100 years. In some embodiments, the precipitation material does not release more than 1% of its total CO₂ when exposed to normal conditions of temperature and moisture, including rainfall of normal pH for at least 1 year. In some embodiments, the precipitation material does not release more than 5% of its total CO₂ when exposed to normal conditions of temperature and moisture, including rainfall of normal pH for at least 1 year. In some embodiments, the precipitation material does not release more than 10% of its total CO₂ when exposed to normal conditions of temperature and moisture, including rainfall of normal pH for at least 1 year. In some embodiments, the precipitation material does not release more than 1% of its total CO₂ when exposed to normal conditions of temperature and moisture, including rainfall of normal pH for at least 10 years. In some embodiments, the precipitation material does not release more than 1% of its total CO₂ when exposed to normal conditions of temperature and moisture including rainfall of normal pH for at least 100 years. In some embodiments, the precipitation material does not release more than 1% of its total CO₂ when exposed to normal conditions of temperature and moisture, including rainfall of normal pH for at least 1000 years.

Any suitable surrogate marker or test that is reasonably able to predict such stability may be used. For example, an accelerated test comprising conditions of elevated temperature and/or moderate to more extreme pH conditions is reasonably able to indicate stability over extended periods of time. For example, depending on the intended use and environment of the precipitation material, a sample of the precipitation material may be exposed to 50, 75, 90, 100, 120, or 150° C. for 1, 2, 5, 25, 50, 100, 200, or 500 days at between 10% and 50% relative humidity, and a loss less than 1%, 2%, 3%, 4%, 5%, 10%, 20%, 30%, or 50% of its carbon may be considered sufficient evidence of stability of precipitation material of the invention for a given period (e.g., 1, 10, 100, 1000, or more than 1000 years).

Any of a number of suitable methods may be used to test the stability of the precipitation material including physical test methods and chemical test methods, wherein the methods are suitable for determining that the compounds in the precipitation material are similar to or the same as naturally occurring compounds known to have the above specified stability (e.g., limestone). CO₂ content of the precipitation material may be monitored by any suitable method, one such non-limiting example being coulometry. Other conditions may be adjusted as appropriate, including pH, pressure, UV radiation, and the like, again depending on the intended or likely environment. It will be appreciated that any suitable conditions may be used that one of skill in the art would reasonably conclude indicate the requisite stability over the indicated time period. In addition, if accepted chemical knowledge indicates that the precipitation material would have the requisite stability for the indicated period this may be used as well, in addition to or in place of actual measurements. For example, some carbonate compounds that may be part of a precipitation material of the invention (e.g., in a given polymorphic form) may be well-known geologically and known to have withstood normal weather for decades, centuries, or even millennia, without appreciable breakdown, and so have the requisite stability.

Precipitation material, which serves to sequester carbon dioxide in a form that is stable over extended periods of time (e.g., geologic time scales), may be stored for extended durations, as described above. The precipitation material may also be mixed with silicon-based material (e.g., from separated silicon-based material after material comprising metal silicates digestion; commercially available SiO₂; etc.) if necessary to achieve a certain ratio of carbonates to silica in order to form pozzolanic material. Pozzolanic materials of the invention are siliceous or aluminosiliceous materials which, when combined with an alkali such as calcium hydroxide (Ca(OH)₂), exhibit cementitious properties by forming calcium silicates and other cementitious materials. SiO₂-containing materials such as volcanic ash, fly ash, silica fume, high reactivity metakaolin, and ground granulated blast furnace slag, and the like may be used to fortify pozzolanic materials of the invention. In some embodiments, pozzolanic materials of the invention are fortified with 0.5% to 1.0%, 1.0% to 2.0%, 2.0% to 4.0%, 4.0% to 6.0%, 6.0% to 8.0%, 8.0% to 10.0%, 10.0% to 15.0%, 15.0% to 20.0%, 20.0% to 30.0%, 30.0% to 40.0%, 40.0% to 50.0%, or an overlapping range thereof, of a SiO₂-containing material.

Spray-dried material (e.g., precipitation material, silicon-based material, pozzolanic material, etc.), by virtue of being spray dried, may have a consistent particle size (i.e., the spray-dried material may have a relatively narrow particle size distribution). As such, in some embodiments, at least 50%, 60%, 70%, 80%, 90%, 95%, 97%, or 99% of the spray-dried material falls within ±10 microns, ±20 microns, ±30 microns, ±40 microns, ±50 microns, ±75 microns, ±100 microns, or ±250 microns of a given mean particle diameter. In some embodiments, the given mean particle diameter is between 5 and 500 microns. In some embodiments, the given mean particle is between 50 and 250 microns. In some embodiments, the given mean particle diameter is between 100 and 200 microns. For example, in some embodiments, at least 70% of the spray-dried material falls within ±50 microns of a given mean particle diameter, wherein the given mean particle diameter is between 5 and 500 microns, such as between 50 and 250 microns, or between 100 and 200 microns.

Generally, pozzolanic material has lower cementitious properties than ordinary portland cement, but in the presence of a lime-rich media like calcium hydroxide, it shows better cementitious properties towards later day strength (>28 days). The pozzolanic reaction may be slower than the rest of the reactions which occur during cement hydration, and thus the short-term strength of concretes that include pozzolanic material of the invention may not be as high as concrete made with purely cementitious materials. The accepted mechanism for this display of strength is the reaction of silicates with lime to form secondary cementitious phases (calcium silicate hydrates with a lower C/S ratio), which display gradual strengthening properties, usually after 7 days. The extent of the strength development ultimately depends upon the chemical composition of the pozzolanic material. Increasing the composition of silicon-based material (optionally with added silica and/or alumina), especially amorphous silicon-based material, generally produces better pozzolanic reactions and strengths. Highly reactive pozzolans, such as silica fume and high reactivity metakaolin may produce “high early strength” concrete that increases the rate at which concrete comprising precipitation material of the invention gains strength.

Precipitation material comprising silicates and aluminosilicates may be readily employed in the cement and concrete industry as pozzolanic material by virtue of the presence of the finely divided siliceous and/or alumino-siliceous material (e.g., silicon-based material). The siliceous and/or aluminosiliceous precipitation material may be blended with portland cement, or added as a direct mineral admixture in a concrete mixture. In some embodiments, pozzolanic material comprises calcium and magnesium in a ratio (as above) that perfects setting time, stiffening, and long-term stability of resultant hydration products (e.g., concrete). Crystallinity of carbonates, concentration of chlorides, sulfates, alkalis, etc. in the precipitation material may be controlled to better interact with portland cement. In some embodiments, precipitation material comprises silica in which 10-20%, 20-30%, 30-40%, 40-50%, 50-60%, 60-70%, 70-80%, 80-90%, 90-95%, 95-98%, 98-99%, 99-99.9% of the silica has a particle size less than 45 microns (e.g., in the longest dimension). In some embodiments, siliceous precipitation material comprises aluminosilica in which 10-20%, 20-30%, 30-40%, 40-50%, 50-60%, 60-70%, 70-80%, 80-90%, 90-95%, 95-98%, 98-99%, 99-99.9% of the aluminosilica has a particle size less than 45 microns (e.g., in the longest dimension). In some embodiments, siliceous precipitation material comprises a mixture of silica and aluminosilica in which 10-20%, 20-30%, 30-40%, 40-50%, 50-60%, 60-70%, 70-80%, 80-90%, 90-95%, 95-98%, 98-99%, 99-99.9% of the mixture has a particle size less than 45 microns (e.g., in the biggest dimension).

Pozzolanic material produced by the methods disclosed herein may be employed as a construction material, which material may be processed for use as a construction material or processed for use in an existing construction material for buildings (e.g., commercial, residential, etc.) and/or infrastructure (e.g., pavements, roads, bridges, overpasses, walls, levees, dams, etc.). The construction material may be incorporated into any structure, the structures further including foundations, parking structures, houses, office buildings, commercial offices, governmental buildings, and support structures (e.g., footings for gates, fences and poles) is considered a part of the built environment. The construction material may be a constituent of a structural or nonstructural component of such structure. An additional benefit of using pozzolanic material as a construction material or in a construction material is that CO₂ employed in the process (e.g., CO₂ obtained from a gaseous waste stream) is effectively sequestered in the built environment.

In some embodiments, pozzolanic material of the invention is employed as a component of a hydraulic cement (e.g., ordinary portland cement), which sets and hardens after combining with water. Setting and hardening of the product produced by combining the precipitation material with cement and water results from the production of hydrates that are formed from the cement upon reaction with water, wherein the hydrates are essentially insoluble in water. Such hydraulic cements, methods for their manufacture and use are described in co-pending U.S. patent application Ser. No. 12/126,776, filed on 23 May 2008, the disclosure of which application is incorporated herein by reference. In some embodiments, pozzolanic material blended with cement is between 0.5% and 1.0%, 1.0% and 2.0%, 2.0% and 4.0%, 4.0% and 6.0%, 6.0% and 8.0%, 8.0% and 10.0%, 10.0% and 15.0%, 15.0% and 20.0%, 20.0% and 30.0%, 30.0% and 40.0%, 40.0% and 50.0%, 50% and 60%, or a range thereof, pozzolanic material by weight. For example, in some embodiments, pozzolanic material blended with cement is between 0.5% and 2.0%, 1.0% and 4.0%, 2.0% and 8.0%, 4.0% and 15.0%, 8.0% and 30.0%, or 15.0% and 60.0% pozzolanic material by weight.

In some embodiments, pozzolanic material is blended with other cementitious materials or mixed into cements as an admixture or aggregate. Mortars of the invention find use in binding construction blocks (e.g., bricks) together and filling gaps between construction blocks. Mortars of the invention may also be used to fix existing structures (e.g., to replace sections where the original mortar has become compromised or eroded), among other uses.

In some embodiments, the pozzolanic material may be utilized to produce aggregates. In some embodiments, aggregate is produced from the precipitation material by forming (e.g. pressing) and subsequent crushing. In some embodiments, aggregate is produced from the precipitation material by extrusion and breaking resultant extruded material. Such aggregates, methods for their manufacture and use are described in co-pending U.S. patent application Ser. No. 12/475,378, filed on 29 May 2009, the disclosure of which is incorporated herein by reference in it entirety.

### EXAMPLES

### Example I

### Nanofiltration/Reverse Osmosis Systems

A. In this prophetic example, nanofiltration and reverse osmosis are used in a system capable of processing 144,000 gallons of seawater per day and producing 2.88 tons of precipitation material per day.

A system is constructed in accordance with FIG. 8 such that a first nanofiltration unit is positioned anterior to the processor, a second nanofiltration unit is positioned posterior to the processor, and a reverse osmosis unit is placed posterior to the second nanofiltration unit. Seawater comprising Ca²⁺ and Mg²⁺ is filtered to remove particulate matter and provided to the first nanofiltration unit, comprising a FilmTec NF270-400 membrane, in order to remove or reduce scaling solutes. Seawater, flowing at a rate of 100 gpm, is concentrated by a factor of 2.6 (75% recovery) by the first nanofiltration unit and delivered as retentate to the processor at a rate of 25 gpm where it is combined with CO₂-charged water or directly charged with CO₂. Following formation of precipitation product (e.g., CaCO₃, MgCO₃), effluent from the processor at a rate of 32 gpm is provided to the second nanofiltration unit, comprising a FilmTec NF270-400 membrane. CO₂ is optionally added prior to nanofiltration to reduce the pH of the processor effluent (e.g., pH 10.5) and preserve membrane life and base value. Processor effluent comprising HCO₃⁻, Ca²⁺, and Mg²⁺ is subsequently concentrated in the second nanofiltration unit retentate by a factor of 2.7 (75% recovery) and recycled back to the processor at a rate of 8 gpm where it is combined with freshly concentrated seawater and charged with additional CO₂ for additional processing. Concomitantly, permeate comprising NaCl from the second nanofiltration apparatus is provided at a rate of 24 gpm to the reverse osmosis unit. The reverse osmosis unit, comprising a Dow FilmTec SW30XLE 400i membrane, concentrates the nanofiltration unit permeate a factor of 2 (50% recovery) and provides the NaCl-rich retentate at a rate of 12 gpm to an electrochemical system (as shown in FIG. 18).

B. In this prophetic example, nanofiltration and reverse osmosis are used in a system capable of processing 144,000 gallons of seawater per day and producing 2.88 tons of precipitation material per day.

A system is constructed in accordance with FIG. 11 such that a nanofiltration unit is positioned posterior to the processor and a reverse osmosis unit is placed posterior to the second nanofiltration unit. Seawater comprising Ca²⁺ and Mg²⁺ is filtered to remove particulate matter and provided the processor at a rate of 100 gpm where it is combined with CO₂-charged water or directly charged with CO₂. Following formation of precipitation product (e.g., CaCO₃, MgCO₃), effluent from the processor at a rate of 133 gpm is provided to the nanofiltration unit, comprising a FilmTec NF270-400 membrane. CO₂ is optionally added prior to nanofiltration to reduce the pH of the processor effluent (e.g., pH 10.5) and preserve membrane life and base value. Processor effluent comprising HCO₃⁻, Ca²⁺, and Mg²⁺ is subsequently concentrated in the nanofiltration unit retentate by a factor of 2.7 (75% recovery) and recycled back to the processor at a rate of 33 gpm where it is combined with freshly concentrated seawater and charged with additional CO₂ for additional processing. Concomitantly, permeate comprising NaCl from the second nanofiltration apparatus is provided at a rate of 100 gpm to the reverse osmosis unit. The reverse osmosis unit, comprising a Dow FilmTec SW30XLE 400i membrane, concentrates the nanofiltration unit permeate a factor of 2 (50% recovery) and provides the NaCl-rich retentate at a rate of 50 gpm to an electrochemical system (as shown in FIG. 18).

### Example II

### Nanofiltration/Reverse Osmosis at a Rate of 48,000 Gallons Per Day

A filtration system comprising a nanofiltration unit and a reverse osmosis unit capable of processing 48,000 gallons of seawater per day produced the following results (Table 1):

TABLE 1
Results of nanofiltration/reverse osmosis.
Proton-Removing Agent Source: None
Water Source: Seawater

| TDS: | | | pH: | | |
|---|---|---|---|---|---|
| NF % Recovery: | | | NF Pressure: | | |
| RO % Recovery: | | | RO Pressure: | | |
| | | NF | NF | RO | RO |
| | Feed | Concentrate | Product | Concentrate | Product |
| | (ppm) | (ppm) | (ppm) | (ppm) | (ppm) |
| Na | 11,000 | 11,760 | NA | 17,300 | 212 |
| Cl | 20,000 | 26,430 | NA | 37,180 | 2790 |
| Ca | 423 | 586 | NA | 360 | 1.5 |
| Mg | 1320 | 2403 | NA | 492 | 2.7 |

Proton-Removing Agent Source: Mg(OH)₂
Water Source: Seawater

| TDS: | | | pH: | | |
|---|---|---|---|---|---|
| NF % Recovery: | | | NF Pressure: | | |
| RO % Recovery: | | | RO Pressure: | | |
| | | NF | NF | RO | RO |
| | Feed | Concentrate | Product | Concentrate | Product |
| | (ppm) | (ppm) | (ppm) | (ppm) | (ppm) |
| Na | 13,000 | 13,700 | NA | 22,460 | 284.3 |
| Cl | 20,500 | 24,200 | NA | 48,990 | 450 |
| Ca | 16 | 55 | NA | 50.4 | 0.39 |
| Mg | 1111 | 1828 | NA | 707.3 | 5.7 |

Proton-Removing Agent Source: Dolomitic Lime
Water Source: Fresh Water

| TDS: | | | pH: | | |
|---|---|---|---|---|---|
| NF % Recovery: | | | NF Pressure: | | |
| RO % Recovery: | | | RO Pressure: | | |
| | | NF | NF | RO | RO |
| | Feed | Concentrate | Product | Concentrate | Product |
| | (ppm) | (ppm) | (ppm) | (ppm) | (ppm) |
| Na | 9107 | 6949 | NA | 12,280 | 77.8 |
| Cl | 15,950 | 11,300 | NA | 26,340 | 128 |
| Ca | 20.1 | 16.97 | NA | 15.48 | 0 |
| Mg | 746.1 | 844.7 | NA | 418.6 | 1.093 |

Proton-Removing Agent Source: Pomona Fly Ash
Water Source: Fresh Water

| TDS: | | | pH: | | |
|---|---|---|---|---|---|
| NF % Recovery: | | | NF Pressure: | | |
| RO % Recovery: | | | RO Pressure: | | |
| | | NF | NF | RO | RO |
| | Feed | Concentrate | Product | Concentrate | Product |
| | (ppm) | (ppm) | (ppm) | (ppm) | (ppm) |
| Na | 133.2 | 230.9 | 92.83 | NA | NA |
| Cl | 56 | 72 | 48 | NA | NA |
| Ca | 2.08 | 65.16 | 9.723 | NA | NA |
| Mg | 62.78 | 0.1492 | 0.0183 | NA | NA |

Proton-Removing Agent Source:
Pomona Fly Ash: 57% NF Recovery
Water Source: Fresh Water

| TDS: | | | pH: | | |
|---|---|---|---|---|---|
| NF % Recovery: | | | NF Pressure: | | |
| RO % Recovery: | | | RO Pressure: | | |
| | | NF | NF | RO | RO |
| | Feed | Concentrate | Product | Concentrate | Product |
| | (ppm) | (ppm) | (ppm) | (ppm) | (ppm) |
| Na | 133.2 | 193.5 | 81.72 | NA | NA |
| Cl | 56 | 68 | 48 | NA | NA |
| Ca | 2.08 | 49.55 | 0.0078 | NA | NA |
| Mg | 62.78 | 0.1327 | 7.28 | NA | NA |

Proton-Removing Agent Source: Pomona Fly Ash
Water Source: Fresh Water

| TDS: | | | pH: | | |
|---|---|---|---|---|---|
| NF % Recovery: | | | NF Pressure: | | |
| RO % Recovery: | | | RO Pressure: | | |
| | | NF | NF | RO | RO |
| | Feed | Concentrate | Product | Concentrate | Product |
| | (ppm) | (ppm) | (ppm) | (ppm) | (ppm) |
| Na | 133.2 | 230.9 | 92.83 | NA | NA |
| Cl | 56 | 72 | 48 | NA | NA |
| Ca | 2.08 | 65.16 | 9.723 | NA | NA |
| Mg | 62.78 | 0.1492 | 0.0183 | NA | NA |

Proton-Removing Agent Source: Pomona Fly Ash
Water Source: Fresh Water

| TDS: | | | pH: | | |
|---|---|---|---|---|---|
| NF % Recovery: | | | NF Pressure: | | |
| RO % Recovery: | | | RO Pressure: | | |
| | | NF | NF | RO | RO |
| | Feed | Concentrate | Product | Concentrate | Product |
| | (ppm) | (ppm) | (ppm) | (ppm) | (ppm) |
| Na | 133.2 | 193.5 | 81.72 | NA | NA |
| Cl | 56 | 68 | 48 | NA | NA |
| Ca | 2.08 | 49.55 | 7.28 | NA | NA |
| Mg | 62.78 | 0.1327 | 0.0078 | NA | NA |

Proton-Removing Agent Source: Pomona Fly Ash
Water Source: Fresh Water

| TDS: | | | pH: | | |
|---|---|---|---|---|---|
| NF % Recovery: | | | NF Pressure: | | |
| RO % Recovery: | | | RO Pressure: | | |
| | | NF | NF | RO | RO |
| | Feed | Concentrate | Product | Concentrate | Product |
| | (ppm) | (ppm) | (ppm) | (ppm) | (ppm) |
| Na | 133.2 | 193.5 | 81.72 | NA | NA |
| Cl | 56 | 68 | 48 | NA | NA |
| Ca | 2.08 | 49.55 | 7.28 | NA | NA |
| Mg | 62.78 | 0.1327 | 0.0078 | NA | NA |

Accordingly, the preceding merely illustrates the principles of the invention. It will be appreciated that those skilled in the art, having read this disclosure, might now be able to devise numerous variations, changes, substitutions, and/or arrangements, which, although not explicitly described or shown herein, embody the principles of the invention, and are included within the spirit and scope of the invention. As such, it should be understood that various alternatives to the embodiments of the invention described herein might be employed in practicing the invention. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

1. (canceled)

2. (canceled)

3. A method comprising:
a) contacting a solution with an industrial source of carbon dioxide to produce a CO2-charged solution;
b) subjecting the CO2-charged solution to conditions sufficient to produce a slurry comprising precipitation material, wherein the precipitation material comprises carbonates, bicarbonates, or carbonates and bicarbonates;
c) separating a supernatant from the slurry; and
d) recirculating at least a portion of the supernatant for contact with the industrial source of carbon dioxide.

4. The method of claim 3, wherein the precipitation material comprises carbonates, bicarbonates, or carbonates and bicarbonates of alkaline earth metals

5. The method of claim 4, wherein the alkaline earth metals are selected from the group consisting of calcium, magnesium, or a combination of calcium and magnesium.

6. (canceled)

7. The method of claim 5, wherein the precipitation material further comprises 3 to 10,000 ppm strontium.

8. The method of claim 5, wherein the separating the supernatant from the slurry comprises dewatering the slurry to produce a dewatering supernatant.

9. The method of claim 8, wherein dewatering the slurry comprises primary dewatering and secondary dewatering.

10. The method of claim 9, wherein primary dewatering produces a primary dewatered product comprising 5-40% solids and a primary dewatering supernatant.

11. (canceled)

12. (canceled)

13. The method of claim 9, wherein secondary dewatering produces a secondary dewatered product comprising 35-99% solids and a secondary dewatering supernatant.

14. (canceled)

15. (canceled)

16. The method of claim 8, wherein the solution for contact with the industrial source of carbon dioxide comprises at least 75% dewatering supernatant.

17. The method of claim 8, further comprising filtering the dewatering supernatant in a filtration system comprising at least one filtration unit.

18. (canceled)

19. The method of claim 17, wherein the filtration system comprises an ultrafiltration unit, a nanofiltration unit, a reverse osmosis unit, or combinations of the foregoing filtration units.

20. The method of claim 19, wherein the dewatering supernatant is treated in a nanofiltration unit to produce a nanofiltration retentate and a nanofiltration permeate.

21. The method of claim 20, wherein at least a portion of nanofiltration unit permeate is processed in an electrochemical process to produce proton-removing agents.

22. The method of claim 20, wherein the nanofiltration unit retentate comprises a concentration of alkaline earth metals that is at least 50% greater than that of the dewatering supernatant.

23. The method of claim 19, wherein the dewatering supernatant is treated in a reverse osmosis unit to produce a reverse osmosis retentate and a reverse osmosis permeate.

24. The method of claim 23, wherein at least a portion of reverse osmosis unit permeate is processed in an electrochemical process to produce proton-removing agents.

25. The method of claim 23, wherein the reverse osmosis unit retentate comprises a concentration of alkaline earth metals that is at least 50% greater than that of the supernatant.

26-28. (canceled)

29. The method of claim 3, wherein recirculating the supernatant for contact with the industrial source of carbon dioxide results in a reduction in total parasitic load of at least 4% when compared to a once-through process.

30. (canceled)

31. (canceled)

32. A system comprising:
a) a processor configured to produce a slurry from an industrial source of carbon dioxide, wherein the slurry comprises precipitation material comprising carbonates, bicarbonates, or carbonates and bicarbonates and
b) a treatment system configured to separate a supernatant from the slurry, wherein the processor and the treatment system are operably connected for recirculation of at least a portion of the supernatant.

33. The system of claim 32, wherein the treatment system comprises a dewatering system configured to separate the supernatant from the slurry.

34. The system of claim 33, wherein the dewatering system is configured to produce a dewatering supernatant.

35. The system of claim 33, wherein the dewatering system comprises a primary dewatering system and a secondary dewatering system

36. The system of claim 35, wherein the primary dewatering system is configured to produce a primary dewatered product comprising 5-40% solids and a primary dewatering supernatant.

37. The system of claim 35, wherein the secondary dewatering system is configured to produce a secondary dewatered product comprising 35-99% solids and a secondary dewatering supernatant.

38. The system of claim 34, wherein the treatment system further comprises a filtration system for filtering the dewatering supernatant, wherein the filtration system comprises at least one filtration unit.

39. (canceled)

40. The system of claim 38, wherein the filtration unit is configured to produce filtration unit retentate and a filtration unit permeate.

41. The system of claim 38, wherein the filtration system comprises an ultrafiltration unit, a nanofiltration unit, a reverse osmosis unit, or combinations of the foregoing filtration units.

42. The system of claim 41, wherein the dewatering system is configured to provide the dewatering supernatant to a nanofiltration unit.

43. The system of claim 42, wherein the nanofiltration unit is configured to produce a nanofiltration unit retentate comprising a concentration of alkaline earth metals that is at least 50% greater than that of the dewatering supernatant.

44. The system of claim 41, wherein the dewatering system is configured to provide the dewatering supernatant to a reverse osmosis unit.

45. The system of claim 44, wherein the reverse osmosis unit is configured to produce a reverse osmosis unit retentate comprising a concentration of alkaline earth metals that is at least 50% greater than that of the dewatering supernatant.

46. The system of claim 40, wherein the processor comprises a contactor selected from the group consisting of a gas-liquid contactor and a gas-liquid-solid contactor.

47. The system of claim 46, wherein the contactor is a multi-stage contactor

48. The system of claim 46, wherein the contactor is configured to utilize the filtration unit retentate provided by the filtration unit.

49. (canceled)

50. The system of claim 40, further comprising an electrochemical system configured to produce proton-removing agents selected from the group consisting of hydroxides, bicarbonates, carbonates, or combinations thereof.

51. (canceled)

52. The system of claim 50, wherein the electrochemical system is configured to use filtration unit permeate or filtration unit retentate from the at least one filtration unit.

53. (canceled)

54. The system of claim 52, wherein the filtration unit is a nanofiltration unit or a reverse osmosis unit.

55-58. (canceled)

59. The system of claim 32, wherein the system provides a reduction in total parasitic load of at least 4% when compared to a system configured for a once-through process.

60-64. (canceled)

65. A method comprising:
a) contacting a solution with an industrial source of carbon dioxide to produce a CO2-charged solution;
b) subjecting the CO2-charged solution to conditions sufficient to produce a composition comprising carbonates, bicarbonates, or carbonates and bicarbonates;
c) treating the composition to produce a concentrated composition, wherein treating the composition comprises
1) dewatering the composition to increase the concentration of carbonates, bicarbonates, or carbonates and bicarbonates in the resulting concentrated composition and to simultaneously produce a supernatant and
2) filtering the supernatant to produce a filter stream; and
d) providing at least a portion of the filter stream to an electrochemical process for producing proton-removing agents.

66. A system comprising:
a) a processor configured to produce a composition from an industrial source of carbon dioxide, wherein the composition comprises carbonates, bicarbonates, or carbonates and bicarbonates;
b) a treatment system configured to concentrate the composition, wherein the treatment system comprises:
1) a dewatering system configured to concentrate carbonates, bicarbonates, or carbonates and bicarbonates in a resulting concentrated composition and simultaneously produce a supernatant and
2) a filtration system configured to produce a filter stream from the supernatant; and
c) an electrochemical system configured to receive at least a portion of the filter stream.
